(19) United States
(12) Patent Application Publication
(10) Pub. No.: US 2022/0002597 A1
(43) Pub. Date: Jan. 6, 2022

(54) ADHESIVES GENERATED FROM SOYBEAN MEAL AND DISTILLER'S DRIED GRAINS WITH SOLUBLES

(71) Applicant: The United States of America, as represented by the Secretary of Agriculture, Washington, DC (US)

(72) Inventor: Brent Tisserat, WASHINGTON, IL (US)

(21) Appl. No.: 17/364,283

(22) Filed: Jun. 30, 2021

Related U.S. Application Data
(60) Provisional application No. 63/046,843, filed on Jul. 1, 2020.

(51) Int. Cl. C09J 103/02; C09J 9/00; B27N 3/08; B27N 3/00; B27N 3/02

(52) U.S. Cl. CPC C09J 103/02; C09J 9/00; C09J 2400/30; B27N 3/002; B27N 3/02; B27N 3/08

(57) ABSTRACT

The invention relates to bio-based adhesives comprising seed flour and distiller's dried grains and solubles (DDGS). The seed flour may be soybean seed flour, and the bio-based adhesive my contain a 50:50 mixture of seed flour and DDGS. The invention also relates to methods for using such bio-based adhesives in the preparation of composite wood panels.

### CROSS-REFERENCE TO RELATED APPLICATIONS

This application claims priority to U.S. Provisional Patent Application No. 63/046,843, filed Jul. 1, 2020, the content of which is expressly incorporated herein by reference in its entirety.

### FIELD OF THE INVENTION

The invention relates to adhesives prepared with seed flour and distiller's dried grains with solubles (DDGS). These bio-based green adhesives are useful, for example, in the preparation of composite wood panels.

### BACKGROUND OF THE INVENTION

Engineered wood panels (EWPs) are composite wood panels (CWPs) consisting of an adhesive matrix binding to a wood filler/reinforcement component. EWPs include particleboard (PB), oriented strand board (OSB), medium density fiberboard (MDF), and high density fiberboard (HDF). EWPs are increasingly employed in the construction industry, and their use was predicted to increase by as much as 33% by 2020.

Eastern redcedar (ERC) (Juniperus virginiana L., family Cupressaceae) trees are considered to be an invasive species; they are found in many eastern portions of the United States. Cedar wood exhibits termite and fungal decay resistance from saproxylic basidiomycete fungi. These characteristics are attributed to the presence of cedar wood oil (CWO), which suggests that CWO is a natural wood preservative. Mature cedar trees provide decorative lumber because of their attractive knotty patterns, but this characteristic detracts from its functionality. Several studies have demonstrated that ERC biomass derived from immature wood and waste shavings can be employed in the manufacture of PB. Commercially produced ERC flakeboard is available.

Petroleum-based thermosetting adhesive resins such as urea-formaldehyde (UF), melamine-formaldehyde (MF), or phenol-formaldehyde (PF) are typically employed as the binding resins to fabricate CWPs. These binding resins may cause environmental and health problems due to the emission of volatile organic compounds (VOCs), such as formaldehyde. Therefore, environmentally benign and safe alternatives such as bio-based adhesive/resins to replace petroleum-based binders are being investigated in the research and industrial communities. Soybean flour (SBM) is one of the most studied bio-based binder. Defatted soy flour contains about 50% protein, which is responsible for its adhesive properties. However, soy flour is relatively expensive, currently at a cost of about US$0.45/lb (US$1.00/Kg). Alternatively, a relatively inexpensive distiller's dried grains and solubles (DDGS) containing about 30% proteins has been found to exhibit excellent binding properties. Currently, the cost of DDGS is about US$0.07/lb (about US$0.15/Kg). World soybean meal production was approximately 235 million metric tons in 2018, including the estimated production of 41.5 million metric tons in the USA.

Prior ERC CWPs were fabricated using petroleum-based resins. One of the major disadvantages of employing bio-based adhesives is poor water resistance. Since ERC EWPs are typically employed for interior locations bio-based adhesives may have an application to serve as an adhesive.

Thus, new economical bio-based green adhesives useful in the preparation of composite wood panels are needed.

### SUMMARY OF THE INVENTION

Provided herein are bio-based green adhesives useful in the preparation of composite wood panels, methods for the preparation of such bio-based adhesives and panels.

In an embodiment, the invention relates a to bio-based adhesive comprising seed flour and DDGS. In some embodiments of the invention, the seed flour in the bio-based material is soybean flour (SBM); or Osage orange seed meal (OOSM). In some embodiments of the invention, the bio-based adhesive consists essentially of seed flour and DDGS. In some embodiments of the invention, the bio-based adhesive is a 50:50 mixture of seed flour and DDGS. In some embodiments of the invention, the seed flour in the bio-based adhesive of the invention is soybean flour (SBM). In some embodiments of the invention, the seed flour and DDGS used to prepare the bio-based adhesive of the invention are ground to about 100 μm to about 300 μm. In some embodiments of the invention, the seed flour and DDGS used to prepare the bio-based adhesive of the invention are ground to about 200 μm to about 250 μm

In an embodiment, the invention relates to a composite wood panel (CWP) fabricated with SBM, DDGS, OOSM, or mixtures thereof, and a wood reinforcement. In some embodiments of the invention, the wood reinforcement in the CWP of the invention is Osage orange wood, Black locust wood, Paulownia wood, mulberry wood, aspen wood, maple wood, oak wood, walnut wood, cedar wood, pine wood, or fir wood. In some embodiments of the invention, the CWP is fabricated with 10%; 15%; 25%; 50%; or 75% of SBM, DDGS, OOSM, or mixtures thereof. In some embodiments of the invention, the CWP is fabricated with a mixture of SBM and DDGS. In some embodiments of the invention, the CWP is fabricated with a mixture of 50% SBM and 50% DDGS. In some embodiments of the invention, the CWP is fabricated with redcedar wood or pine wood. In an embodiment of the invention, the CWP is termite resistant. In some embodiments of the invention, the CWP is fabricated with redcedar wood and a 50:50 mixture of SBM and DDGS.

In an embodiment, the invention relates to a method for fabricating a CWP. The method comprises: mixing equal portions of seed flour and DDGS to create a matrix adhesive portion; transferring the final mixture to a mold; and applying heat and pressure; where 15% or 50% of the matrix adhesive portion is combined with 85% or 50% wood portions.

### BRIEF DESCRIPTION OF THE DRAWINGS

FIG. 1 depicts graphs of the seasonal thermal cycling profiles for accelerated aging studies. Y axis shows the temperature in degrees Celsius (° C.); X axis shows the time in minutes. The solid line shows the winter temperatures; the dotted line shows the spring temperatures; the dashed line shows the summer temperatures; and the dash and dot line shows the fall temperatures.

FIG. 2A to FIG. 2E depict graphs of the color properties of the ingredients and the CPs. Y axis shows the values, X axis shows the different adhesive formulations of the different CPs. In the X axis, a, b, c, d, e, g, i, k, m, and o show results for unmolded materials, and g, h, j, l, n, and p show results for molded materials. a: ERC; b: DDGS; c: OOSM; d: PRO; e and f: 15DDGS-85ERC; g and h: 15 OOSM-85ERC; i and j: 15DDGS/PRO-85ERC; k and l: 50DDGS-50ERC; m and n: 50OOSM-50ERC; o and p: 50DDGS/PRO-50ERC. FIG. 2A shows the L* value measurements; FIG. 2B shows the a* value measurements; FIG. 2C shows the b* value measurements; FIG. 2D shows the C*ab value measurements; and FIG. 2E shows the H* value measurements.

FIG. 3 depicts a graph of the response of wood and CWPs to termite exposure. X axis shows the materials: SP (Southern Pine panel); 15DDGS-85ERC; 50DDGS-50ERC; 15OOSM-85ERC; 50OOSM-50ERC; 15PRO-85ERC; and 50PRO-50ERC. The Y axis shows percentage termite mortality, moisture gain, and weight loss. Means and standard errors are provided; treatment responses with different letters were significantly different (p≤0.05).

FIG. 4A to FIG. 4F depict graphs of the relationship of the effects of resin types and concentrations on the physical, flexural, and dimensional stability properties of CWPs. Composites resins employed: distiller's dried grains with solubles (DDGS)=100% DDGS; PROSANTE soy flour (PRO1)=100% PRO; DDGS/PRO=50% DDGS/50% PRO1. The X axis shows the percentage (%) of each composite in the CPWs. FIG. 4A depicts a graph of the CPW thickness in millimeters (mm). FIG. 4B depicts a graph of the CPW density in kilograms per meter cubed (Kg·m³). FIG. 4C depicts a graph of the CPW modulus of rupture (MOR) in megapaschals (MPa). FIG. 4D depicts a graph of the CPW modulus of elasticity (MOE) in MPa. FIG. 4E depicts a graph of the CPW percentage (%) of water absorption. FIG. 4F depicts a graph of the percentage CPW thickness swelling.

FIG. 5A to FIG. 5F depict graphs of the influence of thermal cycling on the physical, flexural, and dimensional stability properties of various CWPs. The X axis shows the time of use in years. FIG. 5A depicts the CPW thickness at different times in millimeters (mm); FIG. 5B depicts the CPW density in kilograms per meter cubed (Kg·m³); FIG. 5C depicts the CPW MOR in MPa; FIG. 5D depicts the CPW MOE in MPa; FIG. 5E depicts the CPW percentage water absorption (%); and FIG. 5F depicts the CPW percentage (%) thickness swelling.

FIG. 6A TO FIG. 6C depict graphs of the influence of thermal cycling on the surface roughness properties of various CWPs. FIG. 6A depicts Ra values in micrometers (μm); FIG. 6B depict s the Rz values in μm; and FIG. 6C depicts the Ry values in μm. The X axis shows the years of use. In FIG. 6A and FIG. 6B, circles present data for 15DDGS/PRO-85PiW; and triangles present data for 50DDGS/PRO-50PiW. In FIG. 6C, circles present data for 15DDS/PRO-85PiW; and triangles present data for 50DDGS/PR5085PiW.

FIG. 7A to FIG. 7D depict graphs of the thermal cycling influence on the spectral properties of various CWPs. Y axis of FIG. 7A depicts L* value data; FIG. 7B depicts a* value data; FIG. 7C depicts b* value data; FIG. 7D depicts Cab value data; FIG. 7E depicts H* value data. X axis depicts the years of use. Circles present data for 15DDGS/PRO-85PiW; triangles present data for 50DDGS/PRO-50PiW.

FIG. 8A to FIG. 8C depict FT-IR curves for the ingredients used, and for CWPs prepared with such ingredients as a function of time. The Y axis presents the relative absorbance. The X axis presents the wavelength. FIG. 8A depicts data for the ingredients. Solid line shows data for DDGS; large dashes show data for PiW; smaller dashes show data for SBM. FIG. 8B depicts data for CWP prepared with 15DDGS/PRO-85PiW after different periods of use. FIG. 8C depicts data for CWP prepared with 50DDGS/PRO-50PiW after different periods of use. Solid line presents data for 0 years of use; large dashed lines present data for 5 years of use; smaller dashes present data for 7 years of use; and smallest dashes present data for 10 years of use.

FIG. 9A to FIG. 9F depict graphs of the effect of temperature on the ingredients, and as a function of time on the CPWs. FIG. 9A shows the effect of temperature on the weight of the ingredients. FIG. 9B shows derivative thermogravimetric (DTG) curves for the ingredients. FIG. 9C shows the effect of temperature on the weight of CWPs prepared with 15DDGS/PRO-85PiW as a function of time. FIG. 9D shows the DTG of CPWs prepared with 15DDGS/PRO-85PiW as a function of time. FIG. 9E shows the effect of temperature on the weight of CWPs prepared with 50DDGS/PRO-50PiW as a function of time. FIG. 9F shows the DTG of CPWs prepared with 50DDGS/PRO-50PiW as a function of time. For FIG. 9C to FIG. 9F, a solid line presents data for 0 years of use; large dashed lines present data for 5 years of use; smaller dashes present data for 7 years of use; and smallest dashes present data for 10 years of use. The X axis presents the Temperature in degrees Celsius (° C.).

### DETAILED DESCRIPTION

The present invention relates to economic bio-binders consisting of soybean flour (SBM) and distiller's dried grains and solubles (DDGS), and the preparation of composite wood panels (CWP) using DDGS or such economical bio-based binders.

The inventors studied the possibility of employing bio-based seed flours as adhesive/resins to fabricate ERC CWPs. Seed flour proteins are considered to be the primary component in providing adhesive properties for seed flours. In the presence of heat and pressure, proteins polymers denature and unfold to form an aggregation that is capable of binding to wood. The adhesive properties of three different defatted seed flours were employed: a commercial SBM, PROLIA (PRO) or PROSANTE (PRO1), Osage orange seed meal (OOSM), and DDGS. The inventors included soybean meal flour (e.g., PRO) in this study because it is the most commonly employed bio-based adhesive used in fabricating CWPs. Un-defatted SBM contains about 40% protein, about 20% oil, and about 33% carbohydrates. Osage orange (OO) (Maclura pomifera (Raf.) Scheid., family Moraceae) trees are common throughout the eastern USA and produce abundant fruit containing numerous seeds. OO seeds contain about 34% protein, about 33% oil, and about 21% carbohydrates. Currently, OO seeds are processed for industrial oil with the meal discarded. To improve revenues, the inventor sought to develop a use for the seed meal such as an adhesive/resin. DDGS are the solid by-products from ethanol fermentation plants, which are common throughout the Midwest USA. DDGS are composed of about 30% protein, about 10% oil, and about 54% carbohydrates. DDGS are typically sold as an animal feed, but much evidence suggests they are unhealthy. Defatted DDGS and OOSM flours express adhesive properties somewhat comparable to PRO. Eastern redcedar CWPs prepared without using petroleum-based resins would be entirely biodegradable. Eastern redcedar CWPs prepared with 7% UF resins satisfied or exceeded the minimum industry standards for mechanical properties. In the Examples, the flexural properties of “all bio-based” ERC CWPs were compared to the industry standards to determine their potential commercial utilization. Several different adhesive flour dosages mixed with ERC wood to fabricate CWPs, and their flexural and dimensional stability properties were assessed. In addition, the physical properties such as the thickness, density, surface roughness, and color analysis of the CWPs was assessed to determine how they are affected by flour/ERC dosages.

The inventors also sought to determine the adhesive properties of mixing flours derived from two different sources (i.e., DDGS and SBM). In the year 2020, DDGS sell for about US$ 0.07/lb (about US$0.15/kg), while SBM sells for about $0.45/lb (about US$1.00/Kg). Combining a low-cost flour (DDGS) with a high-cost flour (PRO) could result in an acceptable hybrid adhesive flour. Such an adhesive flour would be commercially attractive. As part of their studies, the inventors set up to examine the possibility of employing a solvent-extracted ERC wood as the reinforcement wood for composites. It has previously been found that solvent-extracted CWO can provide biocide protection for non-resistant woods. Prior to the instant experiments, it was unknown if solvent extraction affect the treated ERC wood performance properties. The inventors also tested the biocidal properties of the ERC CWPs prepared without solvent extraction of the ERC. In a prior study, ERC CWPs prepared with 6% or 9% UF exhibited moderate termite resistance. Panels derived from various flour/ERC wood dosages were also tested for termite resistance. It is important to assess how adhesive flour dosages of engineered panels affect the natural biocidal activities of the ERC wood.

The inventors sought to evaluate the possibility of employing DDGS/soy flour mixtures as a less expensive alternative binder to the soy flour alone. Equal concentrations of DDGS and a commercial soybean flour, PROSANTE (PRO1), at various dosages varying from 10% to 75% with pine wood (PiW) were used to fabricate composite wood panels (CWPs). These CWPs were evaluated for their dimensional and morphological stability, and mechanical properties under accelerated aging studies. Fabrication of CWPs consisting of soy flour and DDGS with properties resembling CWPs utilizing soy flour only would considerably lower the cost of bio-based CWPs. However, much information is required to determine the durability of these bio-based CWPs. Past studies have shown that CWPs subjected to exterior environments testing light, moisture, and temperature cause profound structural deterioration. CWPs are employed as indoor building materials such as wall, flooring, and ceiling panels, and are unlikely in this context to be exposed to light and high moisture environments but they would be periodically exposed to extreme temperature changes throughout the year. This situation occurs for CWPs utilized in non-temperature regulated structures (e.g., warehouses, sheds, barns, and storage units).

Various cyclic physical parameters have been employed to evaluate how CWPs respond to aging such as UV light, relative humidity, moisture, and temperature. Accelerated thermal aging has been conducted to determine the durability of composites. Previous accelerated thermal aging studies have employed a synthetic adhesive as the binding agent in the CWP. The inventors have investigated the durability of an entirely bio-based CWP (i.e., DDGS/PRO-PiW panels) to accelerated thermal aging by employing seasonal temperature changes representing spring, summer, autumn, and winter extreme temperatures occurring in Peoria, Ill., USA (40°-43I15″ N 89°36I34″ W).

The stability of CWPs prepared with bio-based binders given up to 2688 thermal cycles representing simulated natural times of 0, 5, 7.5, and 10 years was analyzed, as shown in the Examples. The influence of thermal cycling temperatures on the physical (density and thickness), flexural, dimensional stability, surface roughness, and spectra changes were assessed. In addition, the results of Fourier transform infrared spectroscopy (FTIR) and thermogravimetric analysis (TGA) were conducted to assess the chemical stability of the CWPs.

CWPs fabricated employing 50% DDGS and 50% PROSANTE soybean flours as the matrix with pinewood reinforcements rivaled the flexural properties of CWPs fabricated employing a matrix containing only PROSANTE soybean flour with pine wood reinforcement. An evaluation of how these CWPs would respond to indoor nonthermal building environments that occur in Peoria, Ill., USA was performed using accelerated thermal aging. The effect of ten years of thermal cyclic aging on the performance of CWPs was evaluated using a thermal environmental chamber that mimicked the Peoria, Ill. climate in 24 weeks (168 days) period whose interior CWPs was subjected to non-temperature controlled structures. After 10 years of thermal cyclic, aging all CWPs were found to retain their overall general dimensional shape and properties (i.e., thickness, length, and width). However, accelerated thermal cyclic aging had profound effects on the colorimetry, flexural, surface roughness, and dimensional stability properties of CWPs. Generally, thermal cyclic aging results in an overall deterioration of the CWPs properties, except for their dimensional stability properties, with the maximum loss occurring during the first 5 years of thermal aging. Dimensional stability properties improve after thermal aging. Based on the FTIR spectra, there were no obvious chemical changes in the composites regardless of accelerated thermal aging administered. However, the moisture content at 3920 cm⁻¹ changed, indicating some moisture absorption occurs. TGA maximal peaks of ingredients and CWPs were decidedly different. TGAs showed that there were some thermal changes of CWPs that occurred during the first 5 years, but further aging of the CWPs did not show significant changes.

The inventors fabricated composite wood panels (CWPs) from distiller's dried grains with solubles and eastern redcedar (DDGS-ERC), Osage orange seed meal and eastern redcedar (OOSM-ERC), and defatted commercial soybean meal flour (PROLIA) with eastern redcedar (PRO-ERC) containing 10% to 75% matrices along with 90% to 25% ERC wood. Distiller's dried grain with solubles, OOSM or PRO flours reacted with ERC particles varying from about 1700 μm to produce panels that satisfied the nominal flexural properties required by the European Committee for Standards. The dimensional stability values (i.e., TS and WA) of CWPs dramatically improved when matrices of 50% or 75% were employed. The nominal TS properties of commercial CWPs required by the European Committee for Standards were satisfied by several bio-composite formulations.

The inventors found that surface roughness properties of the ERC CWPs were found to be closely related their composition. Significant Pearson coefficient correlations were found comparing the physical, flexural, dimensional stability, and surface roughness properties. Matrices prepared with equal portions of DDGS and PRO (i.e., 15% DDGS/PRO-85% ERC) produced CWPs that exhibited higher flexural properties than using DDGS alone (i.e., 15DDGS-85ERC) but lower flexural properties than PRO alone (i.e., 15PRO-85ERC). Composite wood panels fabricated from solvent-extracted ERC wood (i.e., 15DDGS/PRO-85RC/HEX or MEOH) with their CWO removed were found to exhibit inferior flexural and dimensional stability properties compared to CWPs fabricated with unextracted ERC wood (i.e., 15DDGS/PRO-85ERC). However, when the proportion of the matrix was increased to 50%, no differences in these properties were detected. The color properties of the mold ERC CWPs were considerably affected by the concentration of the matrices and wood employed. Composite wood panels prepared with ERC can exhibit high termite resistance.

As used herein, “USA” refers to the United States of America.

Other compounds may be added to the bio-based adhesive and/or CWPs, provided they do not substantially interfere with the intended activity and efficacy of such composition; whether or not a compound interferes with activity and/or efficacy can be determined, for example, by the procedures utilized below. Examples of other compounds may include coloring agents or other aesthetic agents.

The amounts, percentages, and ranges disclosed herein are not meant to be limiting, and increments between the recited amounts, percentages, and ranges are specifically envisioned as part of the invention.

As used herein, the term “about” is defined as plus or minus ten percent of a recited value. For example, about 1.0 g means 0.9 g to 1.1 g.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

### EXAMPLES

Having now generally described this invention, the same will be better understood by reference to certain specific examples, which are included herein only to further illustrate the invention and are not intended to limit the scope of the invention as defined by the claims.

### Example 1

### Materials and Preparations

Wood panels were prepared using different amounts of wood; with soybean flour; DDGS; and/or OOSM as binder.

PROLIA (200/90) is a commercial defatted soybean flour (Cargill Inc., Cedar Rapids, Iowa, USA), referred to herein as “PRO”. Distillers dried grains with solubles are a commercial animal corn feed product (Archers Daniel Midland Co., Decatur, Ill., USA), referred to herein as “DDGS”. The OOSM was procured from ground seeds obtained from fruit grown in McLean, Peoria, and Tazewell Counties, Illinois, USA. DDGS and OOSM were defatted with hexane using a Soxhlet extractor. Following defatting, flours were ground with a Thomas-Wiley mill (Model 4, Thomas Scientific, Swedesboro, N.J., USA) using various screens, and then sieved using a RO-TAP testing sieve shaker (Model RX-29, Tyler, Mentor, Ohio, USA) employing 203 mm diameter stainless steel #80 mesh to obtain particles about 250 μm in size. PROLIA (200/90) soybean flour was employed as provided. Defatted PRO, DDGS, and OOSM contained 54%, 30%, and 44% crude protein, respectively.

For some experiments, defatted DDGS was ground to a fine powder in a Ririhong Hi-speed Multifunctional grinder (Model RRH-A500, Shanghai Yuanwo Industrial and Trade Company, Shanghai, China). DDGS flour was then sieved through a #80 U.S. standard screen with a Ro-Tap™ Shaker (Model RX-29, Tyler, Mentor, Ohio, USA) to obtain particles of about 250 μm in size. Commercial soybean flour, PROSANTE (200/90) (hereinafter PRO1) containing 50% protein was employed as provided (Cargill Inc., Cedar Rapids, Iowa, USA). Pine wood shavings (Pinus ponderosa Douglas ex. C. Lawson) (PiW) (PetSmart, Phoenix, Ariz., USA) were used as the wood reinforcement fraction. Using a Thomas-Wiley grinder (Model 4, Thomas Scientific, Swedesboro, N.J., USA) PiW shavings were ground through 4-, 2-, and then 1-mm stainless steel screens to obtain different particle sizes. Milled PiW were sized by sieving with #12 and #30 US standard screens via a shaker. Two PiW mixtures were obtained consisting of 600-1700 μm particles and ≤600 μm particles. In all cases, equal proportions of the two PiW size fractions were employed.

Eastern redcedar wood was procured from trees grown in Woodford County, Illinois, USA. Sapwood was removed with a bandsaw. The heartwood was subjected to compound miter saw cuts to obtain sawdust. Sawdust then was milled successively through 4-, 2-, and 1-mm screens via a Thomas-Wiley mill grinder. Particles were sized employing #12 and #30 US Standard sieves (Newark Wire Cloth Company, Clifton, N.J., USA). The ERC wood portion contained about 50% of particles of approximately 600 μm obtained from particles that passed through the #30 mesh sieve, and about 50% of particles of approximately 600 μm to 1700 μm obtained from particles passing through the #12 mesh sieve and collected on the #30 mesh sieve. In some cases, ERC wood was extracted with hexane or methanol to remove CWO via a Soxhlet extractor. The ERC wood contained ˜6% moisture.

All wood panels prepared consisted of 160 g of ingredients. For some experiments, seed flour dosages of 10%, 15%, 25%, 50%, or 75% of PRO, OOSM, and DDGS were mixed with the balance of ERC wood particles as shown in Table 1, below. Flour mixtures of equal proportions of DDGS and PRO were combined to create 15% or 50% matrix adhesive portions which were mixed with 85% or 50% native ERC, ERC/HEX, or ERC/MEOH wood portions. Seed flour and ERC wood were sealed in a zip-lock bag and mixed for 15 minutes in a compact dryer (Model MCSDRY1S, Magic Chef, Chicago, Ill., USA). Mixed materials were transferred to an aluminum mold (outer dimensions: 15.2 cm W×30.5 cm L×5 cm D and mold cavity: 12.7 cm W×28 cm L×5 cm D). The mold interior was sprayed thoroughly with mold release (Teflon Dry Spray, Chagrin Falls, Ohio, USA). Pressings were conducted using manual hydraulic presses (Model 4126, Carver Press Inc., Wabash, Ind., USA). The mold was then transferred to a preheated Carver press at 185° C. Initially, the molds were given 2.8 MPa pressure for 4 minutes followed by a pressure release, then a press of 4.2 MPa for 4 minutes followed by pressure release, finally a press of 5.6 MPa for 4 minutes. Keeping pressure constant at 5.6 MPa, heating was terminated, and water cooling of the press platens commenced. Molds were removed from press when the mold surface reached 27° C.

TABLE 1
COMPOSITE WOOD PANEL
FORMULATION WEIGHT PERCENTAGES

| Composition | Matrix (%) | ERC (%) |
|---|---|---|
| 10, 15, 25, 50, 75 DDGS-90, 85, 75, | 10, 15, 25, | 90, 85, 75, |
| 50, 25 ERC | 50, 75 | 50, 25 |
| 10, 15, 25, 50, 75 OOSM-90, 85, 75, | 10, 15, 25, | 90, 85, 75, |
| 50, 25 ERC | 50, 75 | 50, 25 |
| 10, 15, 25, 50, 75 PRO-90, 85, 75, 50, | 10, 15, 25, | 90, 85, 75, |
| 25 ERC | 50, 75 | 50, 25 |
| 15, 50 DDGS/PRO-85, 50 ERC | 15, 50 | 85, 50 |
| 15, 50DDGS/PRO-85, 50 ERC/HEX* | 15, 50 | 85, 50 |
| 15, 50DDGS/PRO-85, 50 ERC/MEOH** | 15, 50 | 85, 50 |

*ERC wood extracted with hexane
**ERC wood extracted with methanol

For some examples, CWPs of 10%, 15%, 25%, 50%, and 75% adhesive/resin (DDGS, PRO1, or equal concentrations of DDGS and PRO1 (DDGS/PRO1)) were combined with PiW composed of equal amounts of ≤600 μm particles and 600-1700 μm particles to obtain panels weighing 160 g. In subsequent experiments, CWPs composed of 15% or 50% DDGS/PRO with 85 or 50% PiW were employed in thermal aging. Mixing of adhesive powders and PiW was performed in a zip-lock bag. Mixtures were transferred to an aluminum mold (outer dimensions: 15.2 cm width×30.5 cm length×5 cm depth and mold cavity: 12.7 cm width×28 cm length×5 cm depth) pre-sprayed with a mold release (Paintable Dry Spray with Teflon, No. T212-A, IMS, Chagrin Falls, Ohio, USA). A hydraulic press (Model 4126, Carver Press Inc., Wabash, Ind., USA) was used to compress and mold the samples at a temperature of 185° C. Molds were initially pressed with 2.8 MPa pressure for 4 minutes followed by a release of pressure then pressed to 4.2 MPa for 4 minutes and followed by another pressure release. Molds were finally pressed to 5.6 MPa for an additional 4 minutes. Mold pressure was maintained at 5.6 MPa while the heating was stopped, and the cooling process was commenced via by circulating cold water through the press platens. The mold was removed from the Carver press when the mold surface reached 27° C.

The wood panels prepared in this example were tested in the following examples.

### Example 2

### Testing of Wood Panels

### Accelerated Thermal Cycling

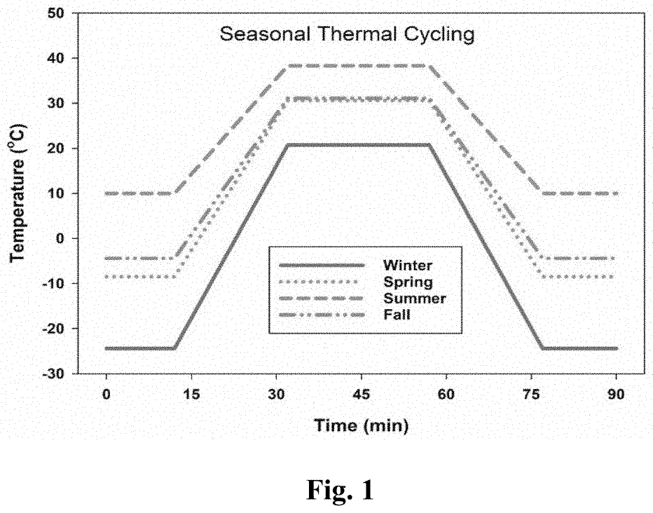

Several CWPs (12.7 cm width×28 cm length×3.5-5.5 mm depth) were placed in a thermal environmental chamber (Model EC127, Sun Electronics Systems, Inc., Titusville, Fla., USA). Panels were subjected to thermal cycling as per the regiment shown in Table 2, below, and FIG. 1. Duration of each cycle was 90 minutes, as shown in FIG. 1. For each season the minimum temperature corresponds to minimum relative humidity (RH); maximum temperature corresponds to maximum RH. Experiments were conducted in complete darkness. These temperatures correspond to the seasonal temperatures that occur in Peoria, Ill., USA. Previously, researchers have suggested that 270 cycles correspond to a “Year of Use. Ninety-minute thermal cycling began in the winter season at −25.6° C., and the heating rate proceeded at 3.5° C. per minute to 23.3° C. for 68 cycles, corresponding to 3 months. Next, the spring season was administered for 68 cycles with temperatures varying from −21.1° C. to 34.4° C., followed by the 68 cycles for the summer season (8.9° C. to 40° C.), and then 68 cycles for the fall season (−12.2° C. to 37.8° C.). Panels were removed at 5, 7.5, and 10 accelerated years for dimensional, flexural, dimensional stability, surface roughness, colorimetric, thermal, and infrared analysis. RH in Peoria varies somewhat during the year, with the highest values (76%) occurring in summer, and the lowest values in winter (69%). However, these are reported as average RH's, and no data are provided as to their minimums or maximums. In our thermal cycling chamber, the lowest temperatures of the season tested correspondingly resulted in the lowest RH's and the higher temperatures resulted in the highest RH's.

TABLE 2
THERMAL CYCLING SETTINGS

| | | Minimum | Maximum | Minimum | Maximum |
|---|---|---|---|---|---|
| Season | Cycles/yr | Temperature (C) | | RH (%) | |
| Winter | 68 | −25.6 | 23.3 | 35.6 | 76.4 |
| Spring | 68 | −21.1 | 34.4 | 38.9 | 77.6 |
| Summer | 68 | 8.9 | 40 | 38.7 | 67.2 |
| Fall | 68 | −12.2 | 37.8 | 37.3 | 73.2 |

### Flexural and Physical Tests

Composite panel molds were conditioned at 25° C. and 50% relative humidity (RH) for 72 hours. A table saw was used to cut suitable specimen boards to conduct three-point bending tests (EN 310 1993). Panels were 50 mm W×127 mm L×3.5 mm to 5.5 mm thick. Five specimen panels of each formulation were tested. Specimen thickness dictates the free span length used to conduct flexural tests with a universal testing machine [Instron Model 1122 (Instron Corp., Norwood, Mass., USA)]. Specimen board dimensions (thickness and density) were measured.

Water absorbance (WA) and thickness swelling (TS) were conducted on 50 mm×50 mm squares submerged for 24 hours according to EN 317 (1993) standards.

Flexural tests to analyze modulus of rupture (MOR) and modulus of elasticity (MOE) were conducted with a universal testing machine [Instron Model 1122 (Instron Corp., Norwood, Mass., USA). Water absorption (WA) and thickness swelling (TS) tests were conducted by submerging the 50×50 mm square samples in water for 24 hours.

Color measurements of 5 locations on sample panels were made using a Chroma Meter CR-400 spectrophoto-colorimeter (Konica Minolta, Ramsey, N.J., USA). The scanner was calibrated with a white tile. With this coordinate system, the L* value [lightness [brightness, ranging from 0 (black) to 100 (white)]; the a* value [redness or green-red coordinate, ranging from −100 (green) to +100 (red)]; the b* value [yellowness or green-red coordinate, [ranging from −100 (blue) to +100 (yellow))); the C*ab value (chromaticity, color saturation); and H* ab (Hue angle, tonality angle)]. C*ab and H*ab values are derived using the formulas: √ (a*2+b*2) and arctan (b*/a*), respectively.

Surface roughness properties were measured with Model SJ-210 surface tester (Mitutoyo Corp., Kanagawa, Japan) fitted with a stylus profile detector. Average roughness (Ra), mean peak-to-valley height (Rz), and maximum roughness (maximum peak-to-valley height) (Ry) were calculated according to ISO 4287 (1997). Five surface roughness readings for each panel were conducted. Tester specifications were: speed: 0.5 mm/s, pin diameter: 10 μm, pin angle: 90°, tracing line (Lt) length: 12.5 mm, cut-off (Xx): 2.5 μm, and scanning arm measuring force: 4 mN. Prior to tests, the detector was calibrated, and all tests were performed at room temperature (25° C.±2° C.).

Wood, matrix ingredients, and molded panels were photographed with a digital camera fitted with 5× optical/2× digital zoom lenses (Model # DSCF707 Cyber-shot 5 MP, Sony Corp., Tokyo, Japan). Surface and sawn-cross sections of panels were examined and photographed.

### FTIR

FTIR spectra of the samples were measured on an ABB Arid Zone FT-IR spectrometer (ABB, Houston, Tex., USA) equipped with a pyroelectric deuterated Tri glycine sulfate (DTGS) detector. All samples were finely ground to a powder (homogenized) prior to testing. Test samples were transparent discs that consisted of 1.00 mg solids homogenized with 300 mg of dry spectronic grade KBr, placed in a KBr die and compressed at 24,000 psi using a Carver press. Absorbance spectra were acquired at 4 cm-¹ resolution and signal-averaged over 32 scans. Spectra were baseline corrected and adjusted for mass differences and normalized to the methylene peak at 2927 cm⁻¹. Multiple homogenized samples for each ingredient and CWPs were analyzed to verify that valid representative FTIR spectra are presented.

### TGA Characterizations

Ingredients and CWPs were ground to a powder (homogenized) in order to be tested. Thermogravimetric analysis (TGA) was conducted using a Model Q50 TGA (TA instruments, New Castle, Del., USA) under nitrogen with 60 mL/minute flow rate. Approximately 10 mg samples were placed on a platinum sample pan, and the pan was loaded with the autosampler. Samples were heated at 10° C. per minute from 25° C. to 800° C. TA Universal Analysis software was used to analyze the results. Several homogenized samples were analyzed in order to present representative TGA and derivative thermogravimetric (DTG) curves.

### Termite Resistance Tests

Composite panels were tested for termite resistance employing a no-choice test (i.e., only one treatment per container) with eastern subterranean termites (Reticulitermes flavipes Kollar, 1837; Blattodea: Rhinotermitidae) according to AWPA E1-17 (2017) with a slight modification for test jar moisture content. Soldiers and worker termites were collected from dead logs located at the Sam D. Hamilton Noxubee National Wildlife Refuge (Starkville, Miss., USA) and kept in the darkness in cut log sections sealed in 30-gallon trash cans. Screw-top jars were filled with 150 g sand along with 20 mL distilled water and equilibrated for 2 hours.

Bio-composite panels and control Southern Pine (SP) 20 mm W×20 L×5 mm D wood wafers were conditioned (33° C., 62%±3%), weighed, and placed on a square of foil on top of the damp sand with one block in each jar. Termites were collected from log sections the day of the test by opening the rotting wood and shaking the termites from the wood through a screen to catch large debris. Termites were then placed in plastic tubs containing moistened towel paper for 2 hours, counted and transferred into jars using an aspirator. A total of 400 termites (396 workers and 4 soldiers) were transferred into each jar and kept in a conditioning chamber at 27° C. and 75%±2% relative humidity for 28 days. After four weeks, the number of live termites were counted. Test samples were brushed to remove sand, conditioned for one week, and re-weighed to determine weight loss as described in AWPA E1-17 (2017). Sample weight loss and termite mortality were recorded after a 28 day exposure to the termites. Six replications of each treatment were conducted.

### Statistical Analysis

Experimental data were analyzed using the Duncan's Multiple Range Test (p≤0.05) (Statistix 9, Analytical Software, Tallahassee, Fla., USA). As applicable, Pearson correlations coefficients compared various variables.

### Example 3

### Influence of Matrix and ERC Dosages on Flexural Properties

The physical, flexural, and dimensional stability properties of composites employing the various DDGS-ERC, OOSM-ERC, and PRO-ERC dosages are given in Table 3, below. As can be gathered from this table, composites that contained higher densities produced panels that had lower thickness. Pearson correlation coefficients comparing the physical, flexural, surface roughness, and dimensional stability properties of all composites are shown in Table 3, below. As can be gathered from the data in this table, significant correlations occurred between panel density and panel thickness properties and flexural properties. Increasing the concentration of wood in the ERC CWPs (i.e., 10:90, 15:85, and 25:75 matrix-ERC (%.wt) composites) resulted in a reduction of flexural properties compared to lowering the wood concentration and increasing the matrix portion concentration (i.e., 50:50 and 75:25 matrix-ERC (%.wt) composites). The highest flexural properties were obtained from composites containing 50:50 matrix-ERC (%.wt). The DDGS-ERC composites had lower flexural properties compared to PRO-ERC and OOSM-ERC composites.

TABLE 3
PHYSICAL, FLEXURAL, AND DIMENSIONAL STABILITY PROPERTIES

| | Thickness | Density | MOR | MOE | WA | TS |
|---|---|---|---|---|---|---|
| Composition | (mm) | (kg · m³) | (MPa) | (MPa) | (A) | (A) |
| 10DDGS-90ERC | 4.5 ± 0.08a | 860 ± 19a | 9.4 ± 0.9a | 1688 ± 142a | 165 ± 13a | 107 ± 8a |
| 15DDGS-85ERC | 4.3 ± 0.06a | 924 ± 7b | 14.9 ± 0.8b | 2134 ± 127b | 123 ± 4b | 88 ± 3b |
| 25DDGS-75ERC | 3.9 ± 0.05b | 1043 ± 17c | 25.0 ± 1.0c | 3816 ± 216c | 84 ± 8c | 69 ± 5c |
| 50DDGS-50ERC | 3.4 ± 0.08c | 1239 ± 19d | 25.2 ± 0.5c | 4063 ± 131c | 37 ± 2d | 36 ± 1d |
| 75DDGS-25ERC | 3.1 ± 0.09c | 1303 ± 38e | 22.6 ± 0.9c | 3771 ± 142c | 33 ± 5d | 35 ± 1d |
| 10OOSM-90ERC | 4.9 ± 0.06d | 835 ± 17a | 14.9 ± 0.6b | 1963 ± 28b | 131 ± 11b | 79 ± 4h |
| 15OOSM-85ERC | 4.8 ± 0.08d | 865 ± 12a | 16.9 ± 1.5b | 2183 ± 106b | 104 ± 4e | 66 ± 3c |
| 25OOSM-75ERC | 4.4 ± 0.05a | 927 ± 12b | 25.7 ± 2.5c | 2875 ± 193d | 59 ± 10f | 56 ± 3c |
| 50OOSM-50ERC | 3.7 ± 0.06b | 1142 ± 25f | 32.3 ± 1.5d | 4316 ± 250c | 38 ± 4d | 36 ± 3d |
| OOSM-ERC 75-25 | 3.4 ± 0.05c | 1271 ± 17d | 31.6 ± 0.8d | 4888 ± 134e | 35 ± 2d | 32 ± 1d |
| 10PRO-90ERC | 4.4 ± 0.04a | 910 ± 10b | 21.0 ± 0.9c | 2315 ± 67b | 80 ± 3c | 48 ± 2e |
| 15PRO-85ERC | 4.4 ± 0.07a | 930 ± 16b | 25.0 ± 1.7c | 2748 ± 144d | 70 ± 5c | 44 ± 2e |
| 25PRO-75ERC | 3.9 ± 0.09b | 1057 ± 26c | 32.9 ± 1.2d | 3818 ± 227c | 49 ± 5f | 37 ± 3d |
| 50PRO-50ERC | 3.5 ± 0.03c | 1236 ± 16d | 32.8 ± 0.8d | 4571 ± 70e | 39 ± 1d | 33 ± 1d |
| 75PRO-25ERC | 3.3 ± 0.12c | 1291 ± 20e | 26.2 ± 0.8c | 4338 ± 76c | 49 ± 3f | 45 ± 2e |
| 15DDGS/ | 4.6 ± 0.06a | 936 ± 12b | 17.5 ± 0.7b | 2235 ± 77b | 93 ± 5ce | 58 ± 1c |
| PRO-85ERC | | | | | | |
| 50DDGS/ | 3.4 ± 0.03c | 1284 ± 14d | 36.0 ± 1.1d | 4729 ± 156e | 31 ± 1d | 32 ± 1d |
| PRO-50ERC | | | | | | |
| 15DDGS/PRO- | 4.7 ± 0.11a | 920 ± 11b | 12.7 ± 1.3b | 1765 ± 212ab | 117 ± 4b | 75 ± 5b |
| 85ERC/HEX | | | | | | |
| 50DDGS/PRO- | 3.4 ± 0.11c | 1283 ± 17d | 31.3 ± 2.6d | 4522 ± 403ce | 37 ± 1d | 35 ± 1d |
| 50ERC/HEX | | | | | | |
| 15DDGS/PRO- | 5.3 ± 0.11f | 811 ± 9g | 7.0 ± 0.4e | 1336 ± 67f | 156 ± 3a | 76 ± 2b |
| 85ERC/MEOH | | | | | | |
| 50DDGS/PRO- | 3.7 ± 0.07b | 1177 ± 19f | 33.3 ± 1.4d | 4659 ± 215e | 44 ± 3f | 38 ± 1d |
| 50ERC/MEOH | | | | | | |

*Means and standard errors (n = 5) within a column with different letters are significantly different (P <0.05).

The nominal flexural and TS properties for interior use CWPs (PB, MDF, and HDF) according to the European Committee for Standards are given in Table 4, below. As seen on Table 3, the density of the ERC CWPs varied greatly and was closely associated with the matrix concentration employed. ERC CWPs exhibited densities that were relatively high compared to commercial CWPs, ranging from 860 to 1290 kg·m⁻³. Densities of commercial PB, MDF and HDF range considerably and are reported at 160 to 800 kg·m⁻³, 450 to 800 kg·m⁻³, and 600 to 1450 kg·m⁻³, respectively. On this basis, ERC CWPs can be considered to be a type of PB, MDF, or HDF. As seen in Table 3, the flexural properties of several ERC composites satisfy these requirements. The flexural properties of the PRO-ERC composites were generally higher than the OOSM-ERC and DDGS-ERC composites. However, the 50OOSM-50ERC and 75OOSM-25ERC composites were on par with the 50PRO-50ERC and 75PRO-25ERC composites.

TABLE 4
Range of European Standards for Nominal Properties of CWPs
Used in Various Interior Dry/Humid Conditions*

| Specifications* | MOR | MOE | TS |
|---|---|---|---|
| (Description, thickness) | (MPa) | (MPa) | (%) |
| PB, 3 mm to 6 mm | 13-20 | 1800-2550 | 14-23 |
| MDF, >2.5 mm to 6 mm | 23-34 | 2700-3000 | 18-35 |
| HB, >3.5 mm to 5.5 mm | 30-44 | 2500-4500 | 10-35 |

*Values for PB, EN 312 (2003); MDF, EN 622-5 (2006) and HB, EN 622-2 (1993).

It is generally accepted that the protein component of the flour is responsible for its adhesive properties. Distiller's dried grain with solubles, OOSM, and PRO contain about 30%, about 44%, and about 54% protein, respectively. Bio-adhesives are composed of different protein types, which could also contribute towards its adhesive properties. The lower protein concentrations are probably responsible for the inferior performance of DDGS composites when compared to OOSM and PRO composites. In a prior study, employing Paulownia wood (PW) as the reinforcement wood, DDGS-PW composites were found to have flexural properties similar to PRO-PW composites, suggesting that the wood species used in the composite has a large influence on its flexural properties. In this study, employing ERC wood, the DDGS CWPs were inferior to PRO and OOSM CWPs. Apparently, PW has a greater ability to bind with DDGS than ERC. Nevertheless, it should be noted that the DDGS composites exhibited flexural properties that exceeded the nominal European Committee for Standards for fiberboard flexural properties.

As can be gathered from the data in Table 3, mixing PRO and DDGS to develop a less expensive soy flour adhesive produced an adhesive with flexural properties that was superior to using DDGS alone, and was only slightly inferior to employing PRO only. The hybrid matrix composites 15DDGS/PRO-85ERC had MOR and MOE values of 17.5 and 2235, respectively. By comparison, the 15DDGS-85 ERC and 15PRO-ERC had MOR and MOE values of 14.9 and 2134 and 25 and 2748, respectively. However, the 50DDGS/PRO-50ERC composite had flexural properties on par with 50PRO-50ERC.

The data in Table 3 also shows that CWPs fabricated with an adhesive consisting of equal parts DDGS and PRO at low concentrations (i.e., 15%) exhibited an increase in MOR and MOE values of 17% and 5%, respectively, versus CWPs employing DDGS only at the same concentration. However, CWPs fabricated with high concentrations of equal parts DDGS and PRO (i.e., 50%) exhibited an increase in MOR and MOE values of 30% and 16%, respectively, versus CWPs employing DDGS alone at the same concentration.

Treatment of ERC wood with solvents to remove CWO resulted in composites that were inferior to non-treated wood. The MOR and MOE values of 15DDGS/PRO-ERC/HEX, 15DDGS/PRO-ERC/MEOH and 15DDGS/PRO-ERC were 12.7 and 1765, 7 and 1336, and 17.6 and 2235, respectively. However, when the matrix concentration was tested at 50% DDGS/PRO their composite flexural properties were all the same regardless of the wood type employed. This observation suggests that the matrix concentration is more significant than the wood treatment to create a composite with high flexural properties.

This example shows that mixing PRO and DDGS to develop a less expensive soy flour adhesive produced an adhesive with flexural properties that was superior to using DDGS alone, and was only slightly inferior to employing PRO only.

### Example 4

### Dimensional Stability of ERC CWPs

As seen in Table 3, increasing the concentration of the adhesive matrix in the CWPs caused an improvement in the dimensional stability properties. Overall, the lowest WA and TS values occurred when the CWPs contained 50% or 75% matrix. This can be attributed to the increased cohesion caused by the binding of the matrix to the wood portions.

The carbohydrate content of the CWP can influence its dimensional stability. Carbohydrates are noted for their poor water resistance in CWPs. In addition, water adsorption and TS values were influenced by the matrix type employed. For example, 10DDGS-90ERC composites exhibited WA and TS values of 165% and 107%, respectively. On the other hand, 10PRO-90ERC composites exhibited WA and TS values of 80% and 48%, respectively. CWPs composed of DDGSs have less protein and more carbohydrates than CWP composed of PRO. This also suggests that less cohesion occurred between the matrix and the wood for the 10DDGS-90ERC composite compared to that of the 10PRO-90ERC composite. As shown in Table 5, below, significant Pearson correlation coefficient values occurred between WA and TS values, and the thickness, density, MOR, and MOE values. The European Committee for Standards nominal properties for CWPs with thickness of 3 mm to 6 mm for TS values are shown in Table 4, and are: PB, 14% to 23%; MDF, 18% to 35%; and HB, 10% to 35%. Comparing the data in Tables 2 and 3, it may be concluded that several ERC CWPs satisfied these nominal properties.

TABLE 5
Pearson Correlation Coefficient Values

| | Thickness | Density | MOR | MOE | Rₐ | R_{z} | R_{y} | WA | TS |
|---|---|---|---|---|---|---|---|---|---|
| Correlations: | (mm) | (Kg · m⁻³) | (MPa) | (MPa) | (μm) | (μm) | (μm) | (%) | (%) |
| Thickness | — | −0.986 | −0.661 | −0.897 | 0.868 | 0.873 | 0.883 | 0.799 | 0.699 |
| (mm) | | | | | | | | | |
| Density | −0.986 | — | 0.659 | 0.909 | −0.867 | −0.891 | −0.899 | −0.804 | −0.720 |
| (Kg · m⁻³) | | | | | | | | | |
| MOR (MPa) | −0.661 | 0.659 | — | 0.879 | −0.771 | −0.733 | −0.777 | −0.894 | −0.873 |
| MOE (MPa) | −0.897 | 0.909 | 0.879 | — | −0.868 | −0.876 | −0.895 | −0.871 | −0.796 |
| Rₐ (μm) | 0.868 | −0.867 | −0.771 | −0.868 | — | 0.978 | 0.990 | 0.800 | 0.756 |
| R_{z} (μm) | 0.873 | −0.891 | −0.733 | −0.876 | 0.978 | — | 0.993 | 0.769 | 0.744 |
| R_{y} (μm) | 0.883 | −0.899 | −0.777 | −0.895 | 0.990 | 0.993 | — | 0.819 | 0.782 |
| WA (%) | 0.799 | −0.804 | −0.894 | −0.871 | 0.800 | 0.769 | 0.819 | — | 0.965 |
| TS (%) | 0.699 | −0.720 | −0.873 | −0.796 | 0.756 | 0.744 | 0.782 | 0.965 | — |

*All compared values were significant (P = 0.05), employing 5 replicates

### Example 5

### Roughness Properties of ERC CWPs

CWPs containing high concentrations of ERC wood invariably exhibited higher surface roughness values. Conversely, the inclusion of higher matrix concentrations (i.e., 50% or 75%) resulted in lower surface roughness values. Surface roughness represents the surface properties (i.e., appearance, feel, interaction to additives or over-layments). Surface roughness is related to the size and frequency of the surface quality, which is caused by fine irregularities on a surface. Rolleri and Roffael (Rolleri, A. and Raffael, E., “Influence of the surface roughness of particleboards and their performance towards coating,” Maderas Cienc. Technol., 2010, 12: 143-148) consider Ra values to represent the most important property in surface roughness analysis. It is notable that ERC CWPs containing bio-based adhesives exhibited Ra values (e.g., 0.5 μm to 3.5 μm) that were considerably less than those exhibited by spruce or Douglas fir PBs (e.g., 5.2 μm to 11.2 μm) utilizing UF adhesives. ERC PB prepared with 9% UF resin and 91% ERC wood exhibited 14.6 μm Ra values. Wood plastic composites of 50% wood flour and 50% polypropylene exhibited Ra values of ˜3.4, which is on par with the ERC CWPs. Bio-based adhesives can provide a relatively smooth surface compared to those found in other CWPs fabricated with plastic resins or petroleum-based resins. Because bio-based panels are hygroscopic, their dimensional stability values vary with the extent of cohesion occurring between the binding agent portion and the reinforcement wood portion. Surface roughness values provide a means of quickly evaluating how bio-based panels will react in wet, humid, or immersed water environments. Wood panels with a high frequency of surface irregularities will exhibit high surface roughness properties and correspondingly poorer dimensional stability properties. As shown in Tables 2, 4, and 5, CWPs containing the low percentages of bio-adhesives exhibited higher surface roughness properties and conversely lower flexural properties and dimensional stability properties. The data in Table 5 shows that significant Pearson coefficients occurred between all these properties, indicating close relationships between themselves.

The removal of CWO from ERC wood to provide a bio-based wood preservative has been studied. The remaining extracted ERC wood was employed as a reinforcement wood for bio-based panels. It is important to understand how the extraction of CWO from ERC wood affects its functionality as a wood reinforcement in bio-based panels in order to use it as a commercial ingredient in CWPs.

### Remaining Sheet Left Blank Intentionally

TABLE 6
SURFACE ROUGHNES PROPERTIES

| | Rₐ | R_{z} | R_{y} |
|---|---|---|---|
| Description | (μm) | (μm) | (μm) |
| 10DDGS-90ERC | 2.9 ± 0.16a | 12.7 ± 0.56a | 21.2 ± 1.06a |
| 15DDGS-85ERC | 3.4 ± 0.31a | 16.8 ± 1.41b | 24.5 ± 1.71a |
| 25DDGS-75ERC | 2.9 ± 0.75a | 12.2 ± 2.75af | 19.6 ± 3.9a |
| 50DDGS-50ERC | 1.2 ± 0.07b | 5.1 ± 0.64c | 7.9 ± 0.94b |
| 75DDGS-25ERC | 0.9 ± 0.12b | 3.4 ± 0.30d | 5.14 ± 0.50c |
| 10OOSM-90ERC | 4.6 ± 0.60c | 17.8 ± 1.93b | 28.1 ± 3.17a |
| 15OOSM-85ERC | 3.1 ± 0.20a | 12.9 ± 0.95a | 20.2 ± 0.95a |
| 25OOSM-75ERC | 3.1 ± 0.47a | 16.0 ± 3.14b | 21.4 ± 2.89a |
| 50OOSM-50ERC | 0.5 ± 0.04d | 2.1 ± 0.19e | 3.3 ± 0.4d |
| 75OOSM-25ERC | 0.7 ± 0.13b | 2.6 ± 0.50de | 3.8 ± 0.47d |
| 10PRO-85ERC | 3.5 ± 0.48a | 15.9 ± 2.32b | 24.3 ± 2.71a |
| 15PRO-85ERC | 2.0 ± 0.23a | 10.0 ± 1.03f | 15.5 ± 1.11e |
| 25PRO-75ERC | 0.7 ± 0.06b | 4.4 ± 0.93cd | 5.8 ± 0.93c |
| 50PRO-50ERC | 0.9 ± 0.04b | 3.3 ± 0.13d | 4.7 ± 0.18c |
| 75PRO-25ERC | 0.8 ± 0.18b | 3.0 ± 0.71d | 4.4 ± 1.08cd |
| 15DDGS/PRO-85ERC | 3.9 ± 0.7a | 18.8 ± 2.9b | 24.7 ± 3.4a |
| 50DDGS/PRO-50ERC | 0.8 ± 0.1b | 2.8 ± 0.3de | 4.4 ± 0.5c |
| 15DDGS/PRO-85ERC/HEX | 6.6 ± 0.7e | 29.8 ± 2.8g | 41.1 ± 3f |
| 50DDGS/PRO-50ERC/HEX | 0.6 ± 0b | 2.4 ± 0.2e | 3.9 ± 0.4c |
| 15DDGS/PRO-85ERC/MEOH | 4.7 ± 0.7c | 20.4 ± 3.1b | 28.8 ± 4.2a |
| 50DDGS/PRO-50ERC/MEOH | 0.5 ± 0.1b | 3 ± 1.1de | 4.1 ± 1.1c |

*Means and standard errors (n = 5) within a column with different letters are significantly different (P < 0.05).

As seen in Table 6, above, solvent extracted ERC wood composites (i.e., 15DDGS/PRO-85ERC/HEX and 15DDGS/PRO-85ERC/MEOH) exhibited considerably higher surface roughness values compared to unextracted ERC wood composites (i.e., 15DDGS/PRO-85ERC). Simultaneously, s shown in Table 3, the flexural properties of solvent extracted ERC wood composites were considerably inferior to those of unextracted ERC wood composites. As shown in Table 5, significant Pearson coefficients occurred between the surface roughness, physical, flexural, and dimensional stability values. Extracted ERC wood causes considerable changes in the surface roughness, flexural, and dimensional stability properties of the CWPs especially when low concentrations of bio-adhesives were employed (i.e., 15DDGS/PRO-85ERC/HEX and 15DDGS/PRO-85ERC/MEOH). However, such changes did not occur when higher concentrations of bio-bases adhesives were employed (e.g., 50DDGS/PRO-50ERC/HEX and 50DDGS/PRO-50ERC/MEOH).

### Example 6

### Color Analysis of CWPs

One the most important characteristics of ERC wood is its attractive red color. The color properties of ERC wood, bio-based matrices, and CWPs are shown in Table 7, below. The lightness (L*), green-red coordinates (a*), blue-yellow coordinates (b*), and chromaticity (color saturation) of the wood were dramatically altered depending on the concentration of the matrix and wood reinforcement components. As can be seen in Table 7, increasing the concentration of the bio-based adhesives resulted in darkening of the wood and significant decreases in lightness, redness, yellowness, and chromatic properties. The H* values were less affected by matrix concentration. For example, 10DDGS-90ERC and 50DDGS-50ERC composites exhibited L*, a*, b*, and C*ab values of 47, 13, 11, and 18; and 27, 7, 7, and 10, respectively. Pearson coefficients comparing the matrix and wood concentrations and color properties are given in Table 7. There were significant correlations between the matrix percentages and L*, a*, b*, and C*ab coordinates. However, there were no observed correlations between the H* values and the other values measured.

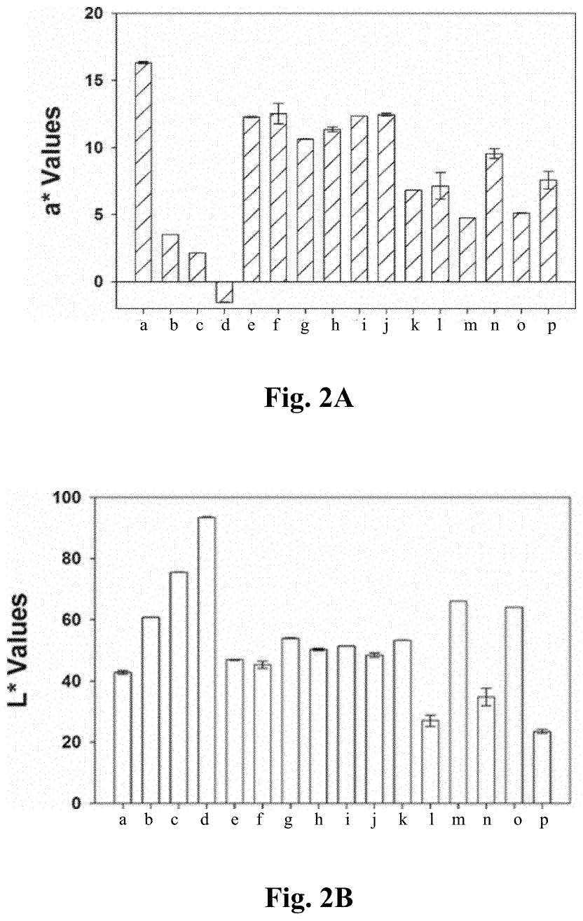

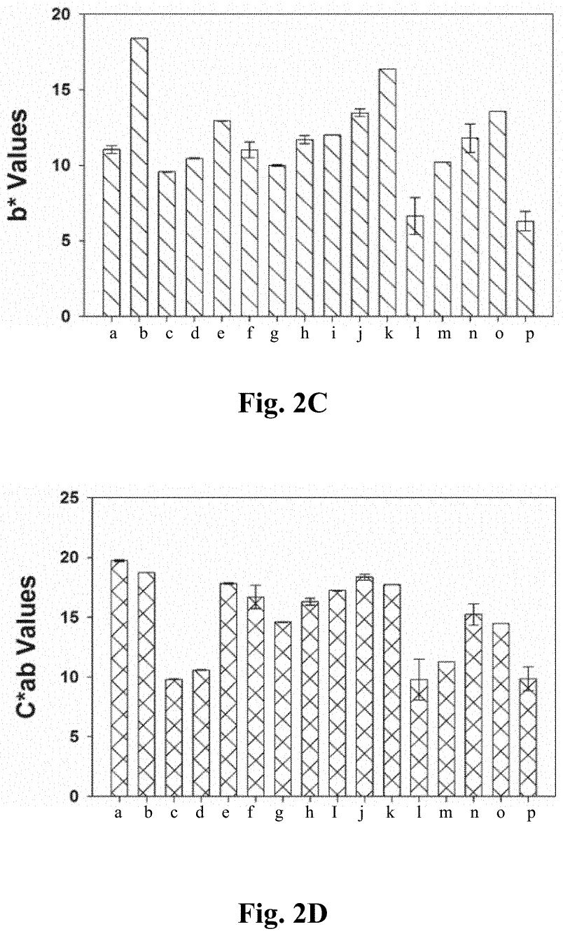

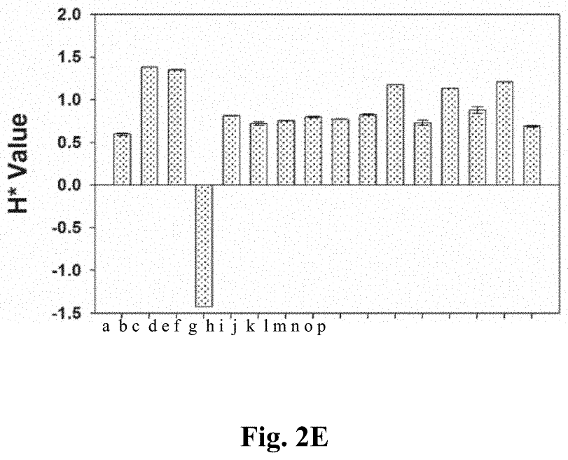

As seen in Tables 6 and 7, below, the color properties of the original ingredients and of the mixture of ingredients were considerably different from the color properties of molded CWPs. This can be attributed to the heating and pressure employed to generate the molded panels. Other investigators reported that heat-treated wood similarly exhibited color alterations, which resulted in decreases in L*, a*, b*, and C*ab values. Heating causes the destruction or alteration of extractives within wood, which causes color changes. In this study, the matrices concentrations contributed to color changes of the molded bio-composite panels. As shown in Table 7 and FIG. 2A to FIG. 2E, the L* coordinates decreased 4% to 7% in the molded CWPs containing 15% matrix and 85% ERC wood versus the unheated original ingredients. The L* coordinates decreased 31% to 63% in the molded CWPs containing 50% matrix and 50% ERC wood versus the unheated original ingredients. As seen in FIG. 2A to FIG. 2E, the other color coordinates values also showed these same trends based on the matrix ingredient concentrations employed.

TABLE 7
COLOR ANALYSIS OF INGREDIENTS AND ERC CWPs

| Description | L* value | a* value | b* value | C*_{ab} value | H* Value |
|---|---|---|---|---|---|
| ERC (≥600 μm)* | 47.8 ± 0.04a | 15.9 ± 0.03a | 13.1 ± 0.01a | 20.5 ± 0.03a | 0.7 ± 0.01a |
| ERC (600-1700 μm)* | 42.8 ± 0.55a | 16.2 ± 0.01a | 11.1 ± 0.25b | 19.7 ± 0.08b | 0.6 ± 0.01a |
| ERC (≥1700 um)* | 44.0 ± 0.45a | 16.3 ± 0.09a | 12.1 ± 0.01c | 20.1 ± 0.01a | 0.6 ± 0.01a |
| DDGS* | 60.8 ± 0.03b | 3.5 ± 0.01b | 18.4 ± 0.01d | 18.7 ± 0.01b | 1.4 ± 0.01b |
| OOSM* | 75.5 ± 0.1c | 2.1 ± 0.01c | 9.6 ± 0.1e | 9.8 ± 0.01c | 1.4 ± 0.01b |
| PRO* | 93.5 ± 0.09d | −1.5 ± 0.01d | 10.5 ± 0.03f | 10.6 ± 0.03d | −1.4 ± 0.01c |
| 50DDGS-50ERC* | 46.9 ± 0.15a | 12.3 ± 0.05e | 12.9 ± 0.02 | 17.8 ± 0.03e | 0.8 ± 0.01d |
| 15DDGS-85ERC* | 53.3 ± 0.04e | 6.8 ± 0.01f | 16.4 ± 0.01 | 17.7 ± 0.01e | 1.2 ± 0.01b |
| 15OOSM-85 ERC* | 53.9 ± 0.10e | 10.6 ± 0.01g | 10 ± 0.1f | 14.6 ± 0.01f | 0.8 ± 0.01d |
| 50OOSM-50 ERC* | 66.1 ± 0.01f | 4.8 ± 0.01h | 10.2 ± 0.1f | 11.3 ± 0.01g | 1.1 ± 0.01b |
| 15DDGS/PRO-85ERC* | 51.4 ± 0.02e | 12.4 ± 0.01e | 12.0 ± 0c | 17.2 ± 0.01e | 0.8 ± 0.01d |
| 50DDGS/PRO-50ERC* | 64.1 ± 0.01f | 5.1 ± 0.01h | 13.6 ± 0.01a | 14.5 ± 0.01f | 1.2 ± 0.01b |
| 10DDGS-90ERC | 47.1 ± 0.51a | 13.3 ± 0.14 | 11.4 ± 0.25b | 17.5 ± 0.21e | 0.7 ± 0.01a |
| 15DDGS-85ERC | 45.2 ± 1.17a | 12.5 ± 0.76e | 11.0 ± 0.53b | 16.7 ± 0.97e | 0.7 ± 0.02a |
| 25DDGS-75ERC | 43.0 ± 2.0a | 12.3 ± 0.39e | 12.0 ± 0.69c | 17.2 ± 0.73e | 0.8 ± 0.03d |
| 50DDGS-50ERC | 27.0 ± 1.86g | 7.1 ± 1.00j | 6.7 ± 1.2ge | 9.8 ± 1.71c | 0.7 ± 0.03a |
| 75DDGS-25ERC | 24.4 ± 1.48g | 4.6 ± 1.04h | 5.5 ± 1.2g | 7.2 ± 1.69g | 0.9 ± 0.03d |
| 10OOSM-90ERC | 50.9 ± 0.54e | 11.6 ± 0.24e | 11.2 ± 0.24b | 16.1 ± 0.31e | 0.8 ± 0.01d |
| 15OOSM-85ERC | 50.2 ± 0.43e | 11.3 ± 0.19i | 11.7 ± 0.26b | 16.3 ± 0.28e | 0.8 ± 0.01d |
| 25OOSM-75ERC | 49.3 ± 0.64e | 10.3 ± 0.25g | 13.2 ± 0.28a | 16.8 ± 0.22e | 0.9 ± 0.02d |
| 50OOSM-50ERC | 34.8 ± 2.96h | 9.5 ± 0.36g | 11.8 ± 0.94b | 15.2 ± 0.88f | 0.9 ± 0.04d |
| OOSM-ERC 75-25 | 25.5 ± 1.25g | 7.1 ± 0.39j | 8.2 ± 0.76e | 10.9 ± 0.91g | 0.9 ± 0.02d |
| 10PRO-85ERC | 47.5 ± 0.89e | 13.0 ± 0.22e | 12.2 ± 0.25 | 17.8 ± 0.11e | 0.8 ± 0.02d |
| 15PRO-85ERC | 47.6 ± 1.35e | 12.13 ± 0.19e | 13.0 ± 0.15a | 17.8 ± 0.13e | 0.8 ± 0.02d |
| 25PRO-75ERC | 36.5 ± 2.81h | 12.3 ± 0.41e | 11.9 ± 0.87b | 17.1 ± 0.91e | 0.8 ± 0.03d |
| 50PRO-50ERC | 24.9 ± 0.72g | 8.7 ± 0.48g | 7.3 ± 0.45e | 11.4 ± 0.71g | 0.7 ± 0.01a |
| 75PRO-25ERC | 23.4 ± 1.8g | 6.5 ± 0.44f | 5.3 ± 0.41g | 8.34 ± 0.65 | 0.7 ± 0.01a |
| 15DDGS/PRO-85ERC | 48.5 ± 0.7e | 12.5 ± 0.10e | 13.5 ± 0.2a | 18.3 ± 0.2 | 0.8 ± 0.02a |
| 50DDGS/PRO-50ERC | 23.5 ± 0.7g | 7.6 ± 0.70j | 6.3 ± 0.6ge | 9.8 ± 1 | 0.7 ± 0.01a |
| 15DDGS/PRO-85ERC/HEX | 49.4 ± 0.5e | 12.6 ± 0.20e | 14.2 ± 0.2h | 19 ± 0.1 | 0.8 ± 0.01a |
| 50DDGS/PRO-50ERC/HEX | 23.5 ± 0.8g | 7.6 ± 0.70j | 5.9 ± 0.7g | 9.6 ± 1.1 | 0.7 ± 0.02a |
| 15DDGS/PRO-85ERC/ST | 54.2 ± 0.3e | 11.5 ± 0.01i | 15.2 ± 0.1g | 19.1 ± 0.1 | 0.9 ± 0.03d |
| 50DDGS/PRO-50ERC/ST | 31.2 ± 1.3i | 10.8 ± 0.4g | 11.4 ± 0.7b | 15.7 ± 0.8 | 0.8 ± 0.01a |

^{a} Means and standard errors (n = 5) within a column with different letters are significantly different (p ≤ 0.05).;
^{b} Description asterisks indicates original ingredients and mixed unmolded ingredients.

TABLE 8
PEARSON CORRELATION COEFFICIENT VALUES

| | Matrix | Wood | L* | a* | b* | C*_{ab} | H* |
|---|---|---|---|---|---|---|---|
| Correlations: | (%) | (A) | value | value | value | value | value |
| Matrix | — | −1.000* | −0.917* | −0.922* | −0.806* | −0.887* | −0.117 |
| Wood | −1.000* | — | 0.917* | 0.922* | 0.806* | 0.887* | 0.117 |
| L* | 0.917* | 0.917* | — | 0.850* | 0.899* | 0.908* | 0.432 |
| a* | −0.922* | 0.922* | 0.850* | — | 0.865* | 0.957* | 0.123 |
| b* | 0.806* | 0.806* | 0.899* | 0.865* | — | 0.974* | 0.583 |
| C*_{ab} | −0.887* | 0.887* | 0.908* | 0.957* | 0.974* | — | 0.393 |
| H* | −0.117 | 0.117 | 0.432 | 0.123 | 0.583 | 0.393 | — |

*Values with asterisks were significant at p − 0.05.

### Example 7

### Termite Responses

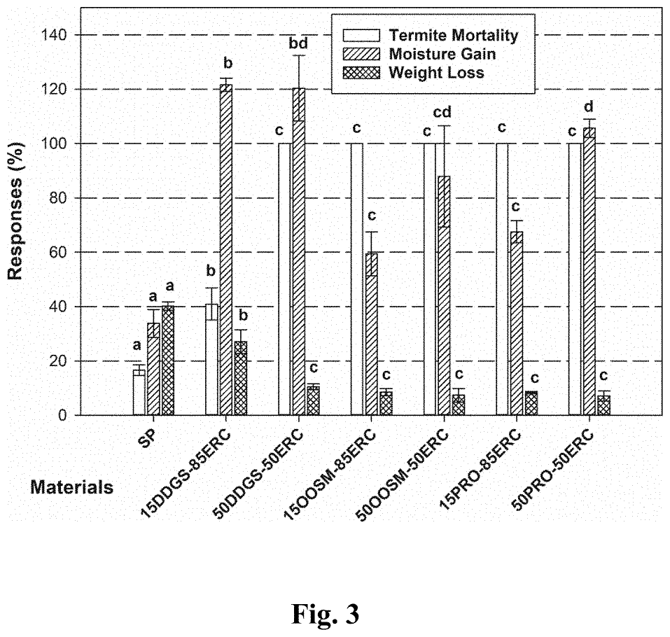

Weight loss, termite mortality, and moisture gain percentages are provided in FIG. 3. Southern pine (SP) control wafers exhibited the least resistance to termites, incurring a 16% termite mortality while complete mortality (100%) was recorded in all but one of the bio-composite panel treatments. Southern pine samples exhibited the least moisture gains compared to CWPs. This can be attributed to the greater structural integrity of the solid wood wafers compared to CWPs. However, SP exhibited the highest percentage of weight loss compared to the CWPs. Eastern redcedar is well documented to be a termiticidal due to the presence of CWO, which is a natural toxin. Eastern Redcedar particleboard-flakeboard panels prepared with 7% UF exhibited up to 95% termite mortality. Similarly, 100% termite mortality was recorded in five of the six CWPs. There was a high significant Pearson coefficient correlation between the termite mortality and the weight loss (0.945). Oddly, the 15DDGS-85ERC panels caused the least termite mortality (41%) of all the bio-composite panels tested. This may be attributed to the poorer binding ability of the DDGS compared to the two-other bio-adhesives (OOSM and PRO). Higher weight losses occurred for 15DDGS-85ERC compared to the other tested CWPs. Likewise, 15DDGS-85ERC also exhibited somewhat lower MOR, MOE, WA, and TS values compared to CWPs utilizing OOSM or PRO matrices (Table 3). This suggests that flexural properties could be related to the dimensional stability and to termite resistance properties. Interestingly, even when 50% of the bio-composite was employed as the bio-adhesive matrix, complete termite mortality was achieved. Apparently, the use of bio-adhesive matrices did not interfere with the termite resistance of the ERC wood. CWPs containing 50% bio-adhesives and 50% ERC were as effective in exhibiting termite resistance and preventing weight loss as CWPs containing 15% bio-adhesives and 85% ERC. Distiller's dried grain with solubles, OOSM, and SBM flours may have termiticidal properties in their own right due the presence of their extractives. Others have reported that PB composed of tobacco stalk and wood particles exhibited termiticidal properties and attributed this to the alkaloid nicotine naturally occurring in tobacco.

### Example 8

### Influence of Resin Type and Concentration on PiW CWPs

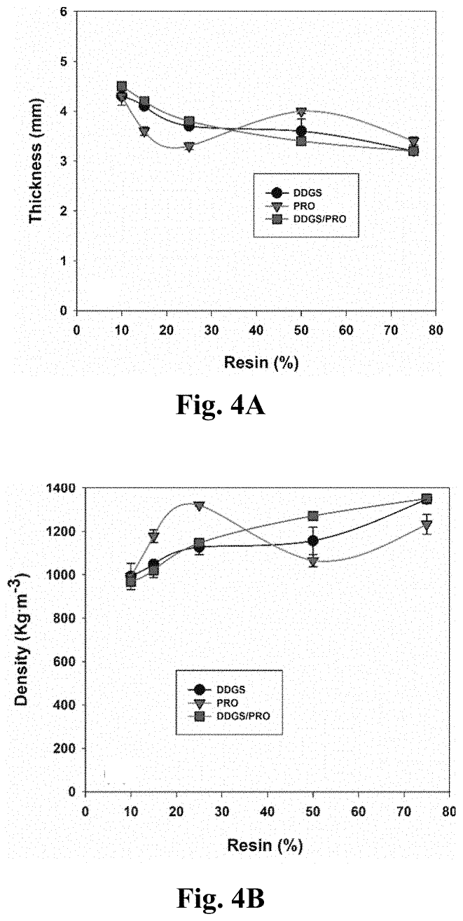

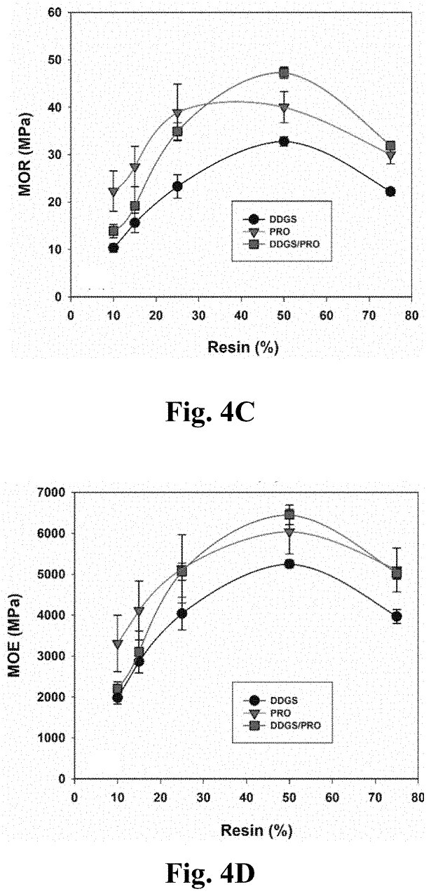

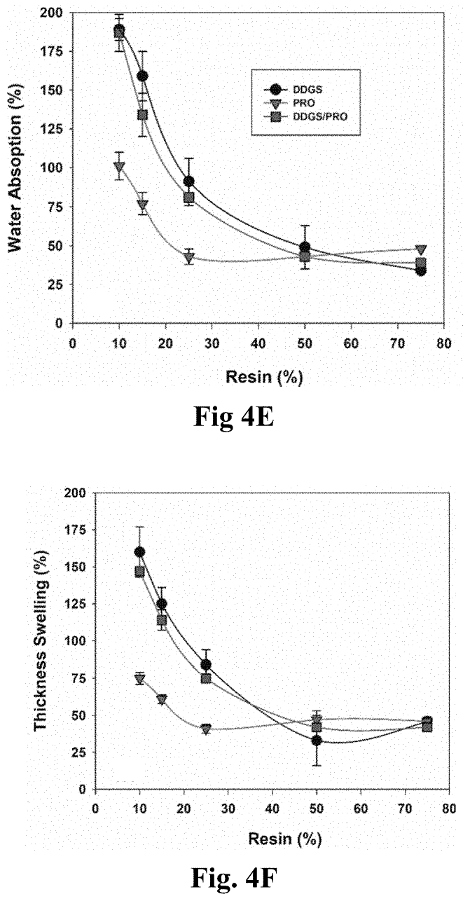

The flexural strength, dimensional stability, and other physical (density and thickness) properties of the CWPs containing various dosages and resin types are presented in FIG. 4. Generally, the thickness of the CWPs was related to the matrix and wood dosage. Overall, these results confirm earlier experiments in which the authors employed various concentrations of bio-based adhesives mixed with wood to fabricate CWPs. CWPs with high matrix dosages and low wood dosages (e.g., 75DDGS-25PiW) were thinner than CWPs containing low matrix dosages and high wood dosages (e.g., 10DDGS-90PiW). As seen in FIG. 4A and FIG. 4B, as the thickness declined, the density of the CWPs increased. Increasing the matrix dosage caused an increase in the flexural properties with the highest flexural properties (MOR and MOE) occurring at the 50% matrix dosage and then declining thereafter at the 75% matrix dosage (FIG. 4C and FIG. 4D). Correspondingly, FIG. 4E and FIG. 4F show that the dimensional stability properties (WA and TS) were lower in panels containing higher matrix dosage concentration. The lowest WA and TS values occurred in CWPs composed of 50% and 75% matrix dosages, while the highest WA and TS values occurred in CWPS composed of 10% and 15% matrix dosages. These observations conform with earlier studies utilizing soybean flour, DDGS, or tree seed flours.

Generally, the flexural and dimensional stability properties of DDGS-PiW composites were inferior to PRO-PiW CWPs. PRO (50%) contained 67% more protein than DDGS (about 30%). Not being bound by theory, this may be attributed to the improved flexural properties of CWPs containing 50% matrix dosages to their higher protein concentrations. Mixing equal proportions of DDSG and PRO produced a matrix fraction that contained approximately 40% protein and resulted in CWPs (DDGS/PRO-PiW) with improved flexural properties compared to the DDGS-PiW composites. Dimensional stability properties of the DDGS/PRO-PiW composites were inferior to the PRO-PiW composites containing the low resin (matrix) concentrations (10%, 15% or 25%). However, at the 50% and 75% resin concentrations, all three composite types (DDGS-PiW, PRO-PiW, and DDGS/PRO-PiW) exhibited similar dimensional stability properties. Not being bound by theory, this may be due to high interfacial binding between the matrix and the reinforcement. Based on these results, since the DDGS/PRO-PiW composites exhibited satisfactory properties they were used in subsequent testing.

### Example 9

### Thermal Cycling of CWPs

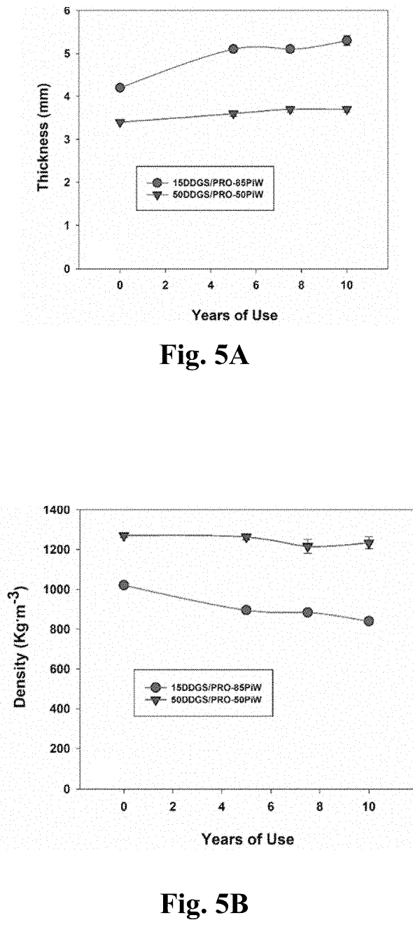

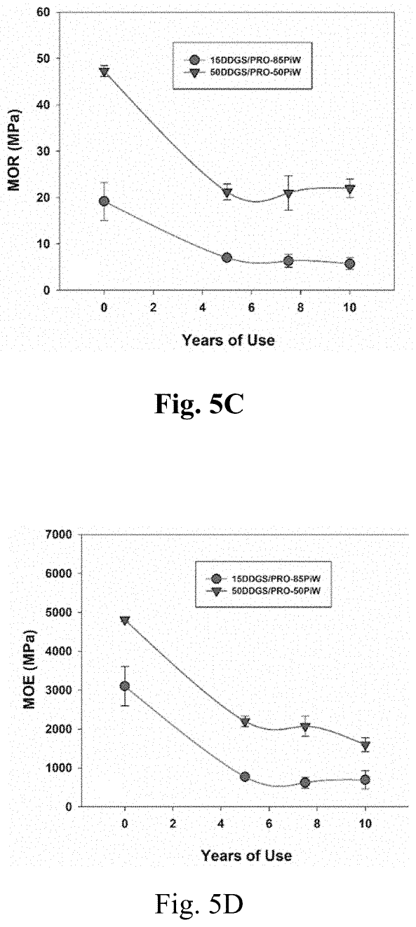

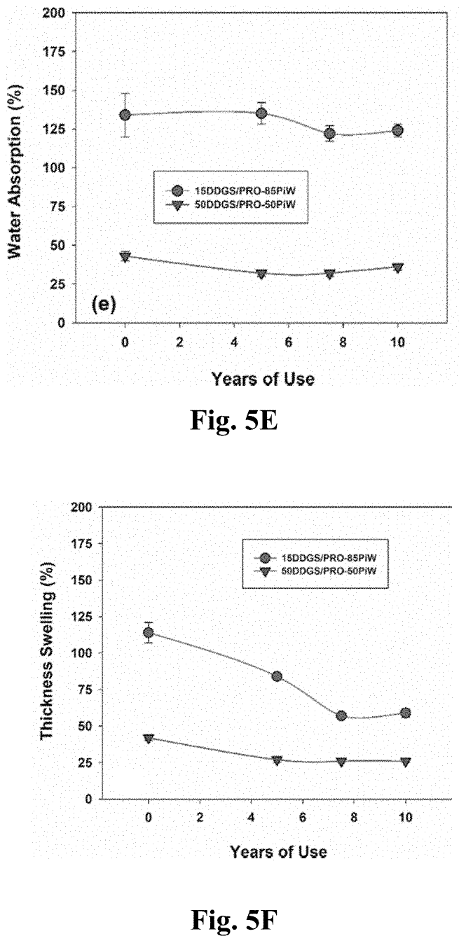

Thermal cyclic aging did not cause an immediate discernible change in the appearance of the CWPs regardless of the years aged. Visually, panels appeared similar in appearance and retained their overall structure form (i.e., length and width). However, detailed examination provided evidence of much alternation due to the thermal aging. For example, changes in physical (density and thickness) and flexural properties of the CWPs as a function of time are presented in FIG. 5A to FIG. 5F. Most significant changes in physical and flexural properties occurred during the first five years of thermal aging. Thickness of the CWPs increased slightly with thermal cycling, while correspondingly density of the composites decreased with thermal cycling. After 5 years of aging, thickness and density values of 15DDGS/PRO-85PiW and 50DDGS/PRO-50PiW exhibited +19% and −12% and +7% and −1% changes, respectively, compared to original untreated CWP (FIG. 5A and FIG. 5B). Likewise, the largest change in the flexural properties of CWPs occurred between 0 and 5 years of use. MOR and MOE values of 15DDGS/PRO-85PiW and 50DDGS/PRO-50PiW exhibited 63% and 75% and 55% and 70% reductions, respectively, compared to untreated controls. Not being bound by theory, this may be due to thermal relaxation of the materials involved. The rate of relaxation decreases as the age of the samples increases beyond five years. Little change in MOR and MOE values occurred after for the 7.5 and 10 years of thermal cycling (FIG. 5C and FIG. 5D). As seen in FIG. 5E and FIG. 5F, changes in dimensional stability values (WA and TS) varied depending on the CWP composition. The 50DDGS/PRO-50PiW CWPs subjected to 5 years of thermal cycling showed 26% reduction in thickness swell compared to a 15DDGS/PRO-85PiW CWP, which exhibited a 36% reduction. Thermal cycling aging actually caused an improvement in the dimensional stability properties of CWPs. Past studies have found that low temperatures such as freezing (0° C.) do not affect the CWP properties. Therefore, the inventors consider that the higher temperatures associated with the spring, summer, and fall seasons are primarily responsible for the change in CWP properties. According to Woodworkingnetwork.com (Temperature Change and Its Effect on Wood, available online at the Woodworking Network Magazine, and accessed on Apr. 3, 2020) when relative humidity is held constant, temperature does not affect wood properties however, when relative humidity is unregulated, temperature greatly affects the relative humidity, and in turn alters the moisture content within the wood, resulting in its expansion and shrinkage. Such physical changes occurring within the CWPs disrupt the bonding between the wood and the matrix resulting in lowering of the CWPs flexural properties. As seen on Table 2, the relative humidity was found to vary greatly depending on the simulated season. Humidity was unregulated in the Examples shown in the instant paper, and the seasonal changes were simulated by administering the extreme temperatures occurring in the season daily. In reality, these temperature extremes do not occur on the same day, but rather gradual temperature changes occur with periodic short-term extremes occurring. Nevertheless, these results provide evidence that dramatic changes occur in CWPs subjected to thermal cycling.

Various accelerated aging techniques on wood panels usually result in severe degradation of their mechanical properties. Prior accelerated aging tests have correlated well with a 2-year natural aging study using commercial CWPs. The employment of a 10-year thermal aging study on commercial CWPs has not been performed to date. Results suggest that shorter-term thermal aging studies correlating to 1 to 5 years should be conducted wherein the influence of CWP moisture content and chamber relative humidity are more closely monitored. Comparison between the European Committee for standardization nominal properties for commercial CWPs and CWPs subjected to thermal cyclic ageing are presented in Table 9, below. As seen in this table, the 15DDGS/PRO-PW and 50DDGS/PRO-PW CWPs had MOR and MOE values that were initially similar to those of commercial panels. Following thermal ageing, these values dropped dramatically and often fell below the nominal standards required for commercial use.

TABLE 9
Comparison with 28052001European
Committee for Standardization nominal properties

| | | | | Thickness |
|---|---|---|---|---|
| | | | | Swelling |
| Description | Density* | MOR** | MOE** | (TS)** |
| type/thickness | (Kg*m⁻³) | (MPa) | (MPa) | (mm) |
| PB, 3-6 mm | 160-800 | 13-20 | 1800-2550 | 14-23 |
| MDF, ≥2.5-6 | 450-800 | 23-34 | 2700-3000 | 18-35 |
| HB, ≥3.5-5.5 | 600-1450 | 30-44 | 2500-4500 | 10-35 |
| 15DDGS/PRO-PW, 0-10 yr | 1021-840 | 19-6 | 3102-689 | 114-59 |
| 50DDGS/PRO-PW, 0-10 yr | 1271-1234 | 47-22 | 6449-1961 | 42-26 |

### Example 10

### Effects of Thermal Cycling

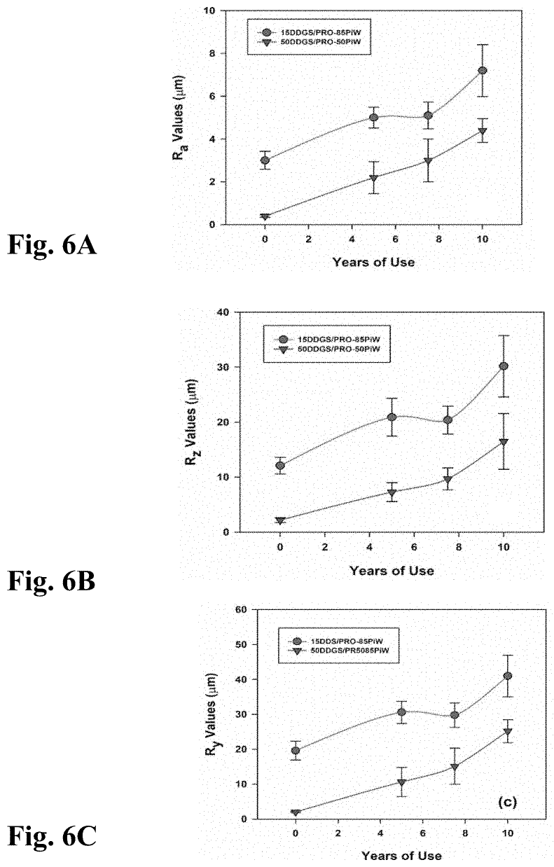

Surface roughness or surface irregularities are important properties of wood panels. Surface roughness affects the tactual sensation, visual aesthetic appeal, behavior of coatings, and the contact relationship to other surfaces. The surface roughness properties of wood panels are related to the composition of the ingredients employed. Weathering of particleboards causes increased surface roughness due to the particle properties' interaction with the matrix. As can be seen in FIG. 6 to FIG. 6C, surface roughness properties were profoundly affected by thermal cycling. The most dramatic increase in surface roughness properties occurred after the first five years of thermal cycling.

Generally, surface roughness properties (Ra, Rz, and Ry) increased as the period of thermal cycling increased (e.g., 15DDGS/PRO-85PiW, 50DDGS/PRO-50PiW). Thermal cycling (e.g., 7.5 and 10 years) resulted in a progressive increase in surface roughness values (FIG. 6A to FIG. 6C). F or example, 50DDGS/PRO-50PiW Ra, Rz, and Ry values at 5, 7.5, and 10 years of thermal cycling increased 265%, 401%, and 675%, respectively, versus values at 0 years of thermal cycling. This corresponds to an increase in surface deterioration caused by a breakdown between the adhesive binding to the wood particles. As seen on FIG. 6A to FIG. 6C, surface roughness appeared to be independent of the resin concentration employed. Surface roughness changes are associated with a deterioration of the surface due to swelling-shrinkage phases brought on by the temperature and relative humidity fluctuations.

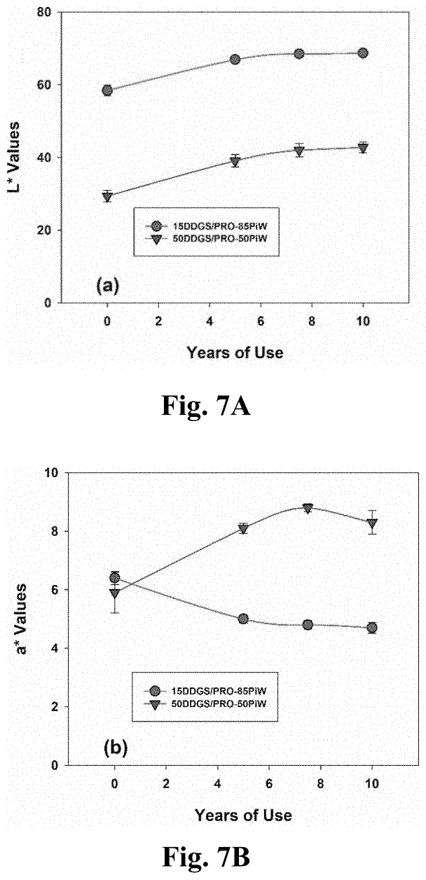

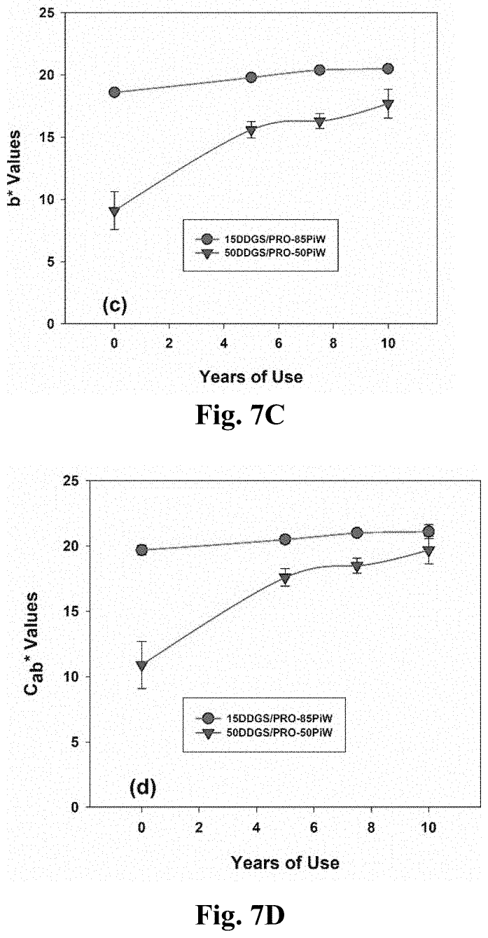

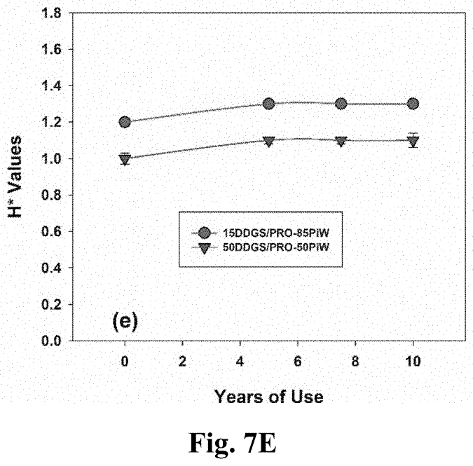

The color of wood is an important aesthetic feature of wood products, but it is not a functional feature. However, as seen on FIG. 7A to FIG. 7E, the type or grade of engineered panels can be affected by the color of the product. Wood is susceptible to weathering and color changes and naturally fades in sunlight. Ultra-violet (UV) rays in sunlight are considered to be the major factor for wood color change. UV inhibitors are routinely added to stains to combat this problem. The inventors observed lightening or fading of the wood with thermal aging. Wood products can exhibit color changes by high temperatures. High temperatures (e.g., about 60-65° C.) cause thermal degradation of hemicellulose and lignin and result in darkening. In the thermal testing described herein, temperatures never exceeded more than 40° C. Yet, over the accelerated thermal aging years a marked lightness of the CWPs occurred. Most of the color changes occurred during the first 5 years of thermal aging, and thereafter no or little color changes occurred (FIG. 7A to FIG. 7E). Color changes in the thermal aging study presented here may have been due to alterations of the chromophores in the carbohydrate portion of the CWPs and alterations of the natural extractives occurring the CWPs in response to the higher temperatures occurring in the spring, summer, and fall periods. Lightness values (L*) increase with thermal aging for both CWPs. However, the 15DDGS/PRO-85PiW composites exhibited less lighting than the 50DDGS/PRO-50PiW composites. For example, the 15DDGS/PRO-85PiW and 50DDGS/PRO-50PiW composites exhibited 18% and 65% increases in L* values, respectively, after 10 years of thermal cycling compared to their initial L* values (FIG. 7A). This was visually apparent when the panels were photographed image. Thermal cycling caused changes in redness values (a*) in all composites. For example, 15DDGS/PRO-85PiW composites exhibited −27% change in a* values, respectively, after 10 years of thermal cycling while 50DDGS/PRO-50PiW exhibited +41% change in a* values, respectively, compared to their initial a* values (FIG. 7B). Overall the blue values (b*), chromaticity values (C*ab) and Hue angle values (H*ab) were found to increase with thermal cycling (FIG. 7C to FIG. 7E). 50DDGS/PRO-50PiW composites exhibited greater increases in b* and C*ab than 15DDGS/PRO-85PiW composites.

### Example 11

### FTIR Spectroscopic Analysis

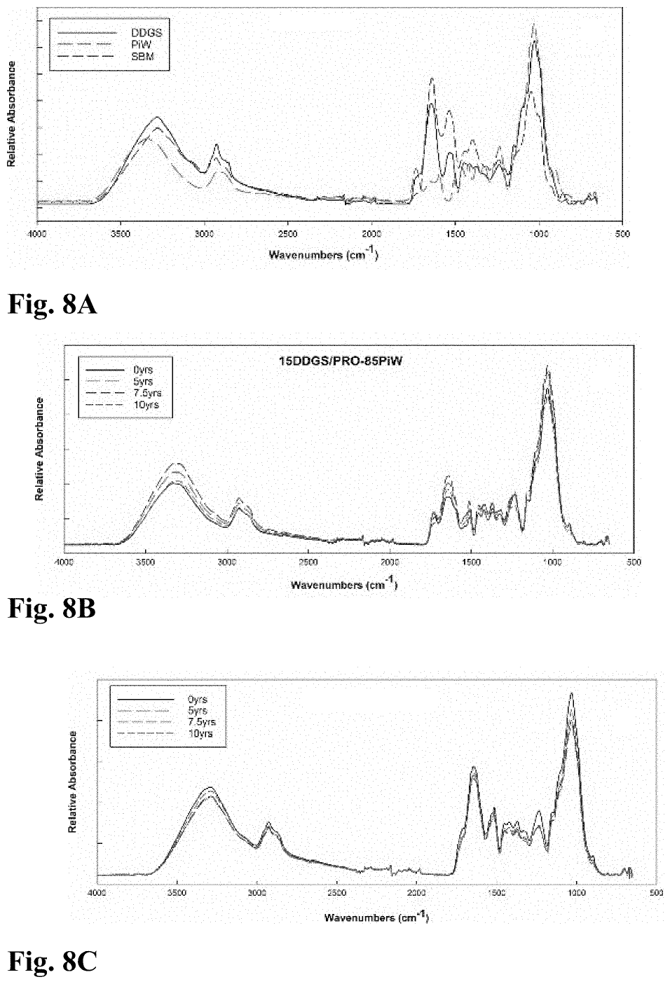

FTIR analysis for ingredients and CWPs are presented in FIG. 8A to FIG. 8C. The FTIR spectra for DDGS, PRP and PiW are shown on FIG. 8A. The FTIR spectra of DDGS and PRO were similar. Both DDGS and PRO showed a prominent peak occurring at the 3276-3284 cm⁻¹ representing the free bound O—H and N—H bending. The PiW ingredient showed this a similar peak at 3347 cm⁻¹. DDGS and PRO showed a prominent peak at 2927-2935 cm⁻¹, which represents the C—H symmetric and asymmetric stretching. PiW showed a similar peak at 2912 cm⁻¹. Three common amide peaks were observed for DDGS and PRO at 1642-1645 cm⁻¹ (C═O stretching, amide I), 1523-1548 cm⁻¹ (N—H deformation, amide II), and 1229-1245 (N—H vibration, amide III). PiW only showed bands at 1634 cm⁻¹ and 1027 cm⁻¹. In contrast, as seen in FIG. 8B and FIG. 8C, CWPs showed similar banding patterns regardless of the accelerating thermal aging process administered. This suggests that few chemical changes occurred within the ingredients of the CWPs during the thermal aging processes. Peak changes in the 3920 cm⁻¹ peak occurred in the 15DDGS/PRO-PW CWPs, indicating some moisture absorption occurs but less so in the 50DDGS/PRO-PW CWPs. This could be attributed to higher binding between the matrix and the wood, which prevented moisture uptake.

### Example 11

### TGA Analysis

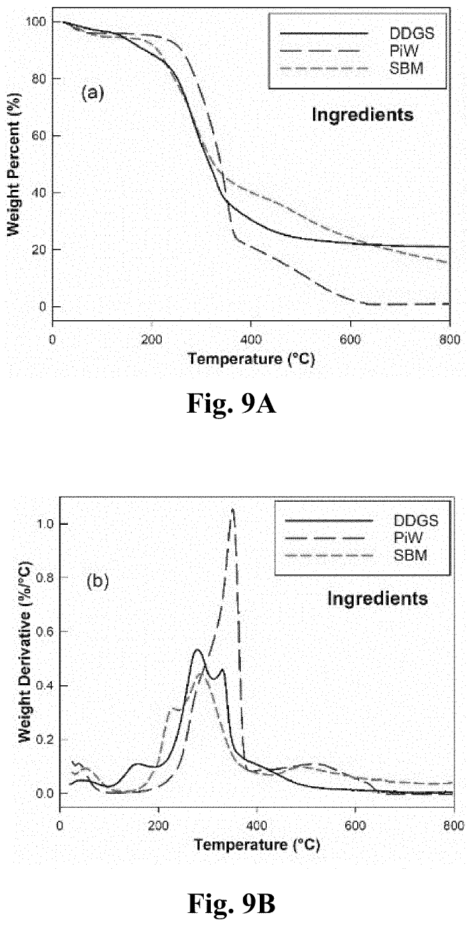

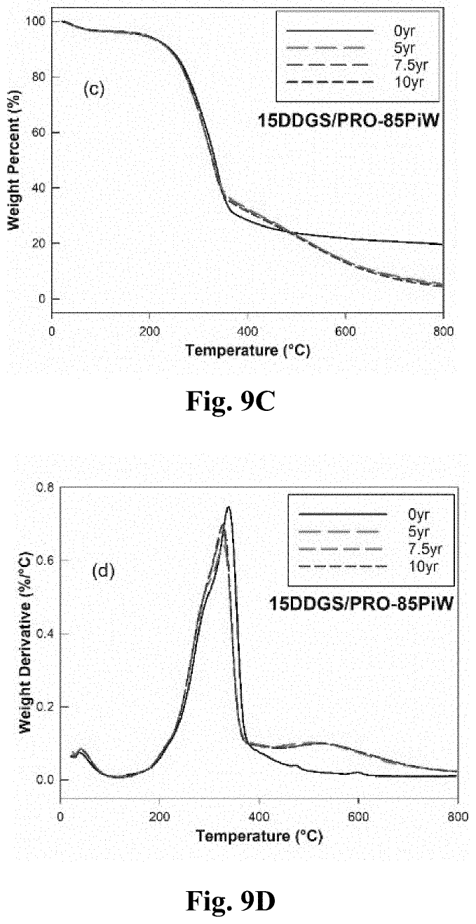

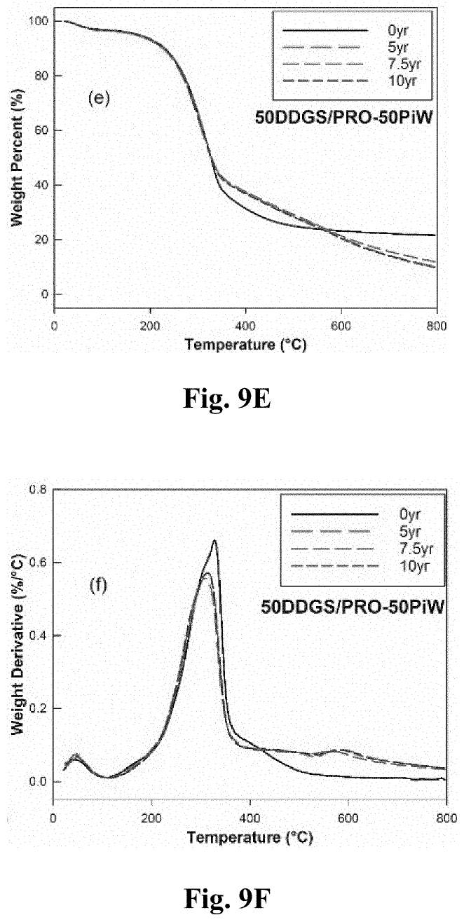

The mass loss as a function of temperature is illustrated in FIG. 9A and FIG. 9B for the ingredients, in FIG. 9C and FIG. 9D for 15 DDGS/PRO-85PiW CWPs, and in FIG. 9E and FIG. 9F for 50 DDGS/PRO-50PiW CWPs. Between 50 and 150-200° C., loss of free and absorbed water occurred for both the ingredients and CWPs. Maximal degradation peak occurred for DDGS and PRO around 280-287° C. The PiW ingredient similarly showed this peak, although its maximum degradation peak occurred at 350° C. Similarly, the maximum degradation peak for 15 DDGS/PRO-85PiW CWPs occurred round 330° C. For the 50 DDGS/PRO-50PiW CWP, the maximal degradation peak occurred at around 308-335° C. This suggests that a gradual shifting of the maximal peak was occurring, probably due to the bonding between the green adhesives (DDGS/PRO) and the reinforcement wood (PiW). Interestingly, there was a shift of the maximal degradation peak for the thermally treated CWPs from 331° C. to 306-316° C. The reduction of this maximal peak is an indication of thermal degradation of the bonding between the adhesive and the wood reinforcement. Soybean-wood composites that exhibited greater TGA mass residues were suggested to have greater thermal stability, which results in greater tensile strength. Similarly, the inventors noted that non-treated CWPs had the highest TGA mass residues and the highest tensile strengths (FIG. 5A to FIG. 5F; and FIG. 9A to FIG. 9F). The residual mass of the original CWPs (i.e., 0 yr 15 DDGS/PRO-85PiW and 50 DDGS/PRO-50PiW) were higher than CWPs subjected to accelerated thermal aging (FIG. 9C and FIG. 9E). For example, residual mass of 0 yr-15 DDGS/PRO-85PiW was 19.7%, and this mass dropped progressively until at 10 yr-15 DDGS/PRO-85PiW it yielded only 4.5%. This indicates that these non-aged CWPs were more thermally stable and had higher binding properties than thermally aged CWPs.

We claim:

1. A bio-based adhesive comprising seed flour and distiller's dried grains and solubles (DDGS).

2. The bio-based adhesive of claim 1, wherein the seed flour is soybean flour (SBM); or Osage orange seed meal (OOSM).

3. The bio-based adhesive of claim 1, wherein the bio-based adhesive consists essentially of seed flour and DDGS.

4. The bio-based adhesive of claim 3, wherein the bio-based adhesive consists essentially of a 50:50 mixture of seed flour and DDGS.

5. The bio-based adhesive of claim 1, wherein the seed flour and DDGS are ground to about 100 μm to about 300 μm.

6. The bio-based adhesive of claim 5, wherein the seed flour and DDGS are ground to about 200 μm to about 250 μm.

7. The bio-based adhesive of claim 1, wherein the seed flour is SBM.

8. A composite wood panel (CWP) fabricated with SBM, DDGS, OOS, or mixtures thereof, and at least one wood reinforcement.

9. The CWP of claim 8, wherein the at least one wood reinforcement is maple wood, oak wood, walnut wood, cedar wood, pine wood, or fir wood.

10. The CWP of claim 8, wherein the wood panel is fabricated with 10%; 15%; 25%; 50%; or 75% of SBM, DDGS, OOSM, or mixtures thereof, and the remaining wood reinforcement.

11. The CWP of claim 8, wherein the panel is fabricated with 15% SBM, DDGS, OOSM, or mixtures thereof, and 85% wood reinforcement.

12. The CWP of claim 8, wherein the SBM, DDGS, OOSM, or mixtures thereof are ground from about 100 μm to about 350 μm.

13. The CWP of claim 12, wherein the SBM, DDGS, OOSM, or mixtures thereof are ground from about 200 μm to about 250 μm.

14. The CWP of claim 8, wherein the wood reinforcement is ground from about 600 μm to about 1,700 μm.

15. The CWP of claim 8, wherein the wood panel is fabricated with a mixture of SBM and DDGS.

16. The CWP of claim 15, wherein the CWP is fabricated with a 50:50 mixture of SBM and DDGS.

17. The CWP of claim 16, wherein the CWP is fabricated with a 15% 50:50 mixture of SBM and DDGS, and 85% reinforcement wood.

18. The CWP of claim 9, wherein the wood reinforcement is pine wood or redcedar wood.

19. A termite resistant CWP, fabricated with redcedar wood, and a 50:50 mixture of SBM and DDGS.

20. A method for fabricating a CWP, the method comprising:
mixing equal portions of seed flour and DDGS to create a matrix adhesive portion;
mixing wood particles with the binder mix to create a final mixture;
transferring the final mixture to a mold; and
applying heat and pressure;
wherein 15% or 50% of the matrix adhesive portion is combined with 85% or 50% wood portions.
